(19) United States
(12) Patent Application Publication
(10) Pub. No.: US 2024/0429381 A1
(43) Pub. Date: Dec. 26, 2024

(54) METHOD FOR FORMING COMPOSITE OXIDE AND METHOD FOR FORMING LITHIUM ION BATTERY

(71) Applicant: SEMICONDUCTOR ENERGY LABORATORY CO., LTD., Atsugi-shi, Kanagawa-ken (JP)

(72) Inventors: Jo SAITO, Atsugi, Kanagawa (JP); Atsushi KAWATSUKI, Yokohama, Kanagawa (JP); Yohei MOMMA, Isehara, Kanagawa (JP); Shuhei YOSHITOMI, Ayase, Kanagawa (JP); Kenta NAKANISHI, Atsugi, Kanagawa (JP); Tetsuya KAKEHATA, Isehara, Kanagawa (JP)

(21) Appl. No.: 18/692,527

(22) PCT Filed: Sep. 9, 2022
(86) PCT No.: PCT/IB2022/058487

§ 371 Date: Mar. 15, 2024

(30) Foreign Application Priority Data
Sep. 24, 2021 (JP) 2021-155050
Nov. 19, 2021 (JP) 2021-188376

(51) Int. Cl. H01M 4/525; C01G 51/00; H01M 10/0525; H01M 10/0569

(52) U.S. Cl. CPC H01M 4/525; C01G 51/66; H01M 10/0525; H01M 10/0569; C01P 2004/03; C01P 2004/52; C01P 2006/40; H01M 2300/004

(57) ABSTRACT

A method for forming a positive electrode active material that can be used for a lithium ion battery having excellent discharge characteristics even in a low-temperature environment is provided. The method includes a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours, a second step in which a first mixture is formed by mixing a fluorine source and a magnesium source to the lithium cobalt oxide subjected to the first step, a third step in which the first mixture is heated at a temperature higher than or equal to 800° C. and lower than or equal to 1100° C. for longer than or equal to 1 hour and shorter than or equal to 10 hours, a fourth step in which a second mixture is formed by mixing a nickel source and an aluminum source to the first mixture subjected to the third step, and a fifth step in which the second mixture is heated at a temperature higher than or equal to 800° C. and lower than or equal to 950° C. for longer than or equal to 1 hour and shorter than or equal to 5 hours.

### TECHNICAL FIELD

The invention disclosed in this specification and the like (hereinafter sometimes referred to as “the present invention” in this specification and the like) relates to a power storage device, a secondary battery, and the like. In particular, the present invention relates to a lithium ion battery.

The present invention relates to an object, a method, or a manufacturing method. Alternatively, the present invention relates to a process, a machine, manufacture, or a composition (composition of matter). Alternatively, the present invention relates to a semiconductor device, a display device, a light-emitting device, a power storage device, a lighting device, an electronic device, or a manufacturing method thereof.

### BACKGROUND ART

In recent years, a variety of power storage devices such as lithium ion batteries, lithium ion capacitors, and air batteries have been actively developed. In particular, demands for lithium ion batteries with high output and high energy density have rapidly grown with the development of the semiconductor industry, for portable information terminals such as mobile phones, smartphones, and laptop computers, portable music players, digital cameras, medical equipment, clean energy vehicles such as hybrid electric vehicles (HVs), electric vehicles (EVs), and plug-in hybrid electric vehicles (PHVs), and the like, and the lithium ion batteries are essential as rechargeable energy supply sources for today's information society.

In a lithium ion battery, charge characteristics and/or discharge characteristics change depending on a charge environment and/or a discharge environment of the battery. For example, it is known that the discharge capacity of a lithium ion battery changes depending on a discharge temperature.

Thus, a lithium ion battery having excellent battery characteristics even in a low-temperature environment is required (e.g., see Patent Document 1).

### REFERENCE

### Patent Document

[Patent Document 1] Japanese Published Patent Application No. 2015-026608

### SUMMARY OF THE INVENTION

### Problems to be Solved by the Invention

Patent Document 1 describes that a lithium ion battery capable of operating even in a low-temperature environment (e.g., lower than or equal to 0° C.) can be obtained with the use of the nonaqueous solvent described in Patent Document 1. However, even the lithium ion battery described in Patent Document 1 does not have high discharge capacity when discharging in a low-temperature environment at the time of this application, and further improvement is desired.

In order to achieve a lithium ion battery capable of operating even in a low-temperature environment, it is required to develop not only a nonaqueous solvent (electrolyte) but also a positive electrode and a negative electrode suitable for a lithium ion battery capable of operating even in a low-temperature environment. More specifically, in the case of a positive electrode, development of a positive electrode active material suitable for a lithium ion battery capable of operating even in a low-temperature environment is required.

An object of one embodiment of the present invention is to provide a positive electrode active material applicable to a lithium ion battery having excellent discharge characteristics even in a low-temperature environment. Specifically, an object of one embodiment of the present invention is to provide a positive electrode active material applicable to a lithium ion battery with high discharge capacity and/or high discharge energy density even when discharge is performed in a low-temperature environment.

Note that in this specification and the like, a “low-temperature environment” is lower than or equal to 0° C. In the case where a “low-temperature environment” is stated in this specification and the like, a given temperature lower than or equal to 0° C. can be selected. For example, in the case where a “low-temperature environment” is stated in this specification and the like, any one of lower than or equal to 0° C., lower than or equal to −10° C., lower than or equal to −20° C., lower than or equal to −30° C., lower than or equal to −40° C., lower than or equal to −50° C., lower than or equal to −60° C., lower than or equal to −80° C., and lower than or equal to −100° C. can be selected.

Another object of one embodiment of the present invention is to provide a lithium ion battery having excellent discharge characteristics even in a low-temperature environment. Another object of one embodiment of the present invention is to provide a lithium ion battery having excellent charge characteristics even in a low-temperature environment.

Specifically, an object is to provide a lithium ion battery with high discharge capacity and/or high discharge energy density even when discharge is performed in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another object is to provide a lithium ion battery with a low decrease rate, in comparison with a value(s) of discharge capacity and/or discharge energy density obtained by discharging at 25° C., even when discharge is performed in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.).

Another object is to provide a secondary battery with high charge voltage. Another object is to provide a highly safe or highly reliable secondary battery. Another object is to provide a secondary battery that hardly deteriorates. Another object is to provide a long-life secondary battery. Another object is to provide a novel secondary battery.

Another object of one embodiment of the present invention is to provide a novel material, a novel active material, a novel power storage device, or a manufacturing method thereof.

Note that the description of these objects does not preclude the existence of other objects. One embodiment of the present invention does not need to achieve all these objects. Other objects can be derived from the descriptions of the specification, the drawings, the claims, and the like.

### Means for Solving the Problems

In order to achieve the above objects and the like, one embodiment of the present invention employs the following structure.

One embodiment of the present invention is a method for forming a composite oxide, including a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours; a second step in which a first mixture is formed by mixing a fluorine source and a magnesium source to the lithium cobalt oxide subjected to the first step; a third step in which the first mixture is heated at a temperature higher than or equal to 800° C. and lower than or equal to 1100° C. for longer than or equal to 1 hour and shorter than or equal to 10 hours; a fourth step in which a second mixture is formed by mixing a nickel source and an aluminum source to the first mixture subjected to the third step; and a fifth step in which the second mixture is heated at a temperature higher than or equal to 800° C. and lower than or equal to 950° C. for longer than or equal to 1 hour and shorter than or equal to 5 hours.

Alternatively, in one embodiment of the present invention, the number of magnesium atoms in the magnesium source is greater than or equal to 0.3% and less than or equal to 3% of the number of cobalt atoms in the lithium cobalt oxide subjected to the first step.

Alternatively, in one embodiment of the present invention, the fluorine source is lithium fluoride, the magnesium source is magnesium fluoride, and a ratio between a molar number M_{LiF} of the lithium fluoride and a molar number M_{MgF2} of the magnesium fluoride is M_{LiF}:M_{MgF2}=x:1 (0.1≤x≤0.5).

Alternatively, in one embodiment of the present invention, the number of nickel atoms in the nickel source is greater than or equal to 0.05% and less than or equal to 4% of the number of cobalt atoms in the lithium cobalt oxide subjected to the first step.

Alternatively, in one embodiment of the present invention, the number of aluminum atoms in the aluminum source is greater than or equal to 0.05% and less than or equal to 4% of the number of cobalt atoms in the lithium cobalt oxide subjected to the first step.

Alternatively, in one embodiment of the present invention, the first step is performed in an atmosphere containing oxygen in a state where a lid is put on a sagger containing the lithium cobalt oxide.

Alternatively, one embodiment of the present invention is a method for forming a lithium ion battery including a positive electrode containing a positive electrode active material, an electrolyte, and a negative electrode containing a negative electrode active material that is a carbon material, and the positive electrode active material is formed through a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours; a second step in which a first mixture is formed by mixing a fluorine source and a magnesium source to the lithium cobalt oxide subjected to the first step; a third step in which the first mixture is heated at a temperature higher than or equal to 800° C. and lower than or equal to 1100° C. for longer than or equal to 1 hour and shorter than or equal to 10 hours; a fourth step in which a second mixture is formed by mixing a nickel source and an aluminum source to the first mixture subjected to the third step; and a fifth step in which the second mixture is heated at a temperature higher than or equal to 800° C. and lower than or equal to 1100° C. for longer than or equal to 1 hour and shorter than or equal to 5 hours.

Alternatively, one embodiment of the present invention is a method for forming a lithium ion battery including a positive electrode containing a positive electrode active material, an electrolyte, and a negative electrode containing a negative electrode active material that is a carbon material, in which the electrolyte contains ethylene carbonate, ethyl methyl carbonate, and dimethyl carbonate and a ratio of volume V_{EC} of the ethylene carbonate, volume V_{EMC} of the ethyl methyl carbonate, and volume V_{DMC} of the dimethyl carbonate is V_{EC}:V_{EMC}:V_{DMC}=x:y:100−x−y (5≤x≤35 and 0<y<65) when a total content of the ethylene carbonate, the ethyl methyl carbonate, and the dimethyl carbonate is set to 100 vol %, and the positive electrode active material is formed through a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours; a second step in which a first mixture is formed by mixing a fluorine source and a magnesium source to the lithium cobalt oxide subjected to the first step; a third step in which the first mixture is heated at a temperature higher than or equal to 800° C. and lower than or equal to 1100° C. for longer than or equal to 1 hour and shorter than or equal to 10 hours; a fourth step in which a second mixture is formed by mixing a nickel source and an aluminum source to the first mixture subjected to the third step; and a fifth step in which the second mixture is heated at a temperature higher than or equal to 800° C. and lower than or equal to 1100° C. for longer than or equal to 1 hour and shorter than or equal to 5 hours.

### Effect of the Invention

One embodiment of the present invention can provide a composite oxide (positive electrode active material) applicable to a lithium ion battery having excellent discharge characteristics even in a low-temperature environment. Specifically, a positive electrode active material applicable to a lithium ion battery with high discharge capacity and/or high discharge energy density even when discharge is performed in a low-temperature environment can be provided.

Another embodiment of the present invention can provide a lithium ion battery with high discharge capacity and/or high discharge energy density even when discharge is performed in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.). Another embodiment of the present invention can provide a lithium ion battery with a low decrease rate, in comparison with a value(s) of discharge capacity and/or discharge energy density obtained by discharging at 25° C., even when discharge is performed in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.).

Another embodiment of the present invention can provide a secondary battery with high charge voltage. Another embodiment of the present invention can provide a highly safe or highly reliable secondary battery. Another embodiment of the present invention can provide a secondary battery that hardly deteriorates. Another embodiment of the present invention can provide a long-life secondary battery. Another embodiment of the present invention can provide a novel secondary battery.

Another embodiment of the present invention can provide a novel material, a novel active material particle, a novel power storage device, or a manufacturing method thereof.

### BRIEF DESCRIPTION OF THE DRAWINGS

FIG. 1A to FIG. 1D are diagrams showing methods for forming a positive electrode active material.

FIG. 2 is a diagram showing a method for forming a positive electrode active material.

FIG. 3A to FIG. 3C are diagrams showing methods of forming a positive electrode active material.

FIG. 4A to FIG. 4D are cross-sectional views illustrating examples of a positive electrode of a secondary battery.

FIG. 5A is an exploded perspective view of a coin-type secondary battery, FIG. 5B is a perspective view of the coin-type secondary battery, and FIG. 5C is a cross-sectional perspective view thereof.

FIG. 6A illustrates an example of a cylindrical secondary battery. FIG. 6B illustrates the example of the cylindrical secondary battery. FIG. 6C illustrates an example of a plurality of cylindrical secondary batteries. FIG. 6D illustrates an example of a power storage system including the plurality of cylindrical secondary batteries.

FIG. 7A and FIG. 7B are diagrams illustrating examples of a secondary battery, and FIG. 7C is a diagram illustrating the internal state of the secondary battery.

FIG. 8A to FIG. 8C are diagrams illustrating an example of a secondary battery.

FIG. 9A and FIG. 9B are external views of a secondary battery.

FIG. 10A to FIG. 10C are diagrams illustrating a method for forming a secondary battery.

FIG. 11A illustrates a structure example of a battery pack, FIG. 11B illustrates a structure example of the battery pack, and FIG. 11C illustrates a structure example of the battery pack.

FIG. 12A is a perspective view of a battery pack of one embodiment of the present invention, FIG. 12B is a block diagram of the battery pack, and FIG. 12C is a block diagram of a vehicle including a motor.

FIG. 13A to FIG. 13D are diagrams illustrating examples of transport vehicles. FIG. 13E is a diagram illustrating an example of an artificial satellite.

FIG. 14A and FIG. 14B are diagrams illustrating power storage devices of one embodiment of the present invention.

FIG. 15A is a diagram illustrating an electric bicycle, FIG. 15B is a diagram illustrating a secondary battery of the electric bicycle, and FIG. 15C is a diagram illustrating an electric motorcycle.

FIG. 16A to FIG. 16D are diagrams illustrating examples of electronic devices.

FIG. 17A illustrates examples of wearable devices, FIG. 17B is a perspective view of a watch-type device, and FIG. 17C is a diagram illustrating a side surface of the watch-type device.

FIG. 18 is a graph showing particle size distribution of lithium cobalt oxide described in Example 1.

FIG. 19A is a diagram showing SEM observation results of lithium cobalt oxide described in Example 1, and FIG. 19B is a diagram showing SEM observation results of lithium cobalt oxide that is a starting material.

FIG. 20 is a photograph showing the appearance of a secondary battery.

FIG. 21 is a graph showing discharge curves (temperature characteristics) of a secondary battery with respect to temperatures.

FIG. 22 is a graph showing charge curves and discharge curves of a secondary battery with respect to temperatures.

### MODE FOR CARRYING OUT THE INVENTION

Embodiments of the present invention will be described in detail with reference to the drawings as appropriate. Note that the present invention is not limited to the following description, and it will be readily understood by those skilled in the art that modes and details of the present invention can be modified in various ways without departing from the spirit and scope of the present invention. Therefore, in the embodiments of the present invention described below, reference numerals denoting the same portions are used in common in different drawings. Furthermore, the embodiments and examples described below can be implemented by being combined with any of the embodiments, examples, and the like described in this specification and the like unless otherwise mentioned.

“Electronic devices” in this specification and the like mean all devices including power storage devices, and electro-optical devices including power storage devices, information terminal devices including power storage devices, and the like are all electronic devices.

Note that in this specification and the like, a “power storage device” refers to every element and device having a function of storing power. For example, a power storage device (also referred to as a “secondary battery”) such as a lithium ion battery, a lithium ion capacitor, and an electric double layer capacitor are included.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[]”, a set direction which shows all of the equivalent orientations is denoted with “<>”, an individual plane which shows a crystal plane is denoted with “( )”, and a set plane having equivalent symmetry is denoted with “{}”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g. the theoretical capacity of LiNiO₂ is 275 mAh/g, and the theoretical capacity of LiMn₂O₄ is 148 mAh/g.

The remaining amount of lithium that can be inserted into and extracted from a positive electrode active material can be represented by x (the occupancy rate of Li in lithium sites) in a compositional formula, e.g., LiₓCoO₂. In the case of a positive electrode active material included in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, x≤0.24, and means, for example, 0.1<x≤0.24 in consideration of the practical range of using LiₓCoO₂ as the positive electrode active material of the lithium ion battery.

In the case where lithium cobalt oxide almost satisfies the stoichiometric proportion, lithium cobalt oxide is LiCoO₂ and x=1. In a secondary battery after its discharge ends, it can be said that contained lithium cobalt oxide is also LiCoO₂ and x=1. In general, in a lithium ion battery using LiCoO₂, the discharge voltage rapidly decreases before discharge voltage reaches 2.5 V. For this reason, in this specification and the like, for example, a state in which voltage becomes 2.5 V (counter electrode is lithium) at current of 100 mA/g or lower is regarded as a state in which discharge ends with x of 1. Accordingly, for example, in order to obtain lithium cobalt oxide with x of 0.2, charge may be performed at 219.2 mAh/g in a state in which discharge ends.

Charge capacity and/or discharge capacity used for calculation of x in LiₓCoO₂ is preferably measured under the condition where there is no influence or small influence of a short circuit and/or decomposition of an electrolyte. For example, it is not preferable to use data of a secondary battery, containing a sudden change in voltage or capacity that seems to result from a short circuit, for calculation of x.

The space group of a crystal structure is identified by XRD, electron diffraction, neutron diffraction, or the like. Thus, in this specification and the like, belonging to a space group, being attributed to a space group, or being a space group can be rephrased as being identified as a space group.

Note that a structure is referred to as a “cubic close-packed structure” when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

In this specification and the like, a “layered rock-salt crystal structure of a composite oxide containing lithium and a transition metal” refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a “rock-salt crystal structure” refers to a structure in which cations and anions are alternately arranged. Note that a cation or anion vacancy may be included.

In this specification and the like, “uniformity” refers to a phenomenon in which, in a solid made of a plurality of elements (e.g., A, B, and C), a certain element (e.g., A) is distributed with similar features in specific regions. Specifically, it is acceptable for the specific regions to have substantially the same concentration of the element. For example, a difference in the concentration of the element between the specific regions can be 10% or less. Examples of the specific regions include a surface portion, a surface, a projected portion, a depressed portion, and an inner portion.

In this specification and the like, “segregation” refers to a phenomenon in which in a solid made of a plurality of elements (e.g., A, B, and C), a certain element (e.g., B) is spatially non-uniformly distributed. Alternatively, “segregation” means that the concentration of a certain element is different from those of the other elements. This may be rephrased as uneven distribution, precipitation, non-uniformity, deviation, a mixture of a high-concentration portion and a low-concentration portion, or the like.

In this specification and the like, a “surface portion” of a particle of an active material or the like is a region that is less than or equal to 50 nm, preferably less than or equal to 35 nm, further preferably less than or equal to 20 nm, most preferably less than or equal to 10 nm inward from the surface, for example. A plane generated by a slipping or a crack can be considered as a In this specification and the like, a region at a position deeper than the surface portion surface. is referred to as an “inner portion” in some cases. In this specification and the like, a “grain boundary.” refers to a portion where particles adhere to each other, a portion where crystal orientation changes inside a particle (including a central portion), a portion including many defects, a portion with a disordered crystal structure, or the like. The grain boundary is one of plane defects. The “vicinity of a grain boundary.” refers to a region positioned within 20 nm, preferably within 10 nm from the grain boundary. In this specification and the like, a “particle” is not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

### Embodiment 1

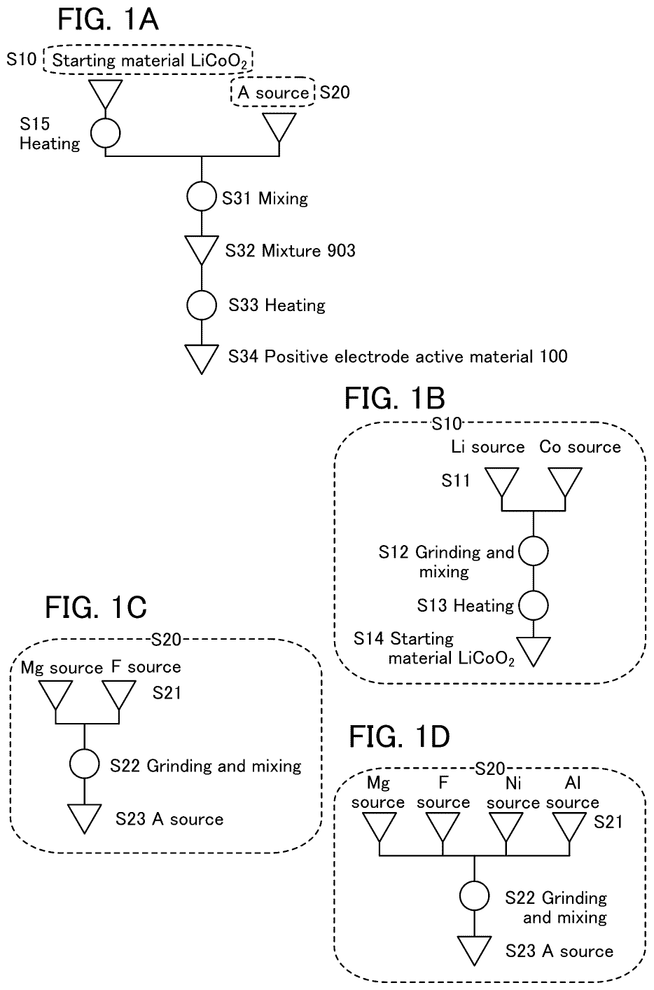

In this embodiment, a method for forming a positive electrode active material applicable to a lithium ion battery having excellent discharge characteristics even in a low-temperature environment is described with reference to FIG. 1 to FIG. 3.

### <Example 1 of Method for Forming Positive Electrode Active Material>

An example of a method for forming a positive electrode active material that can be used as one embodiment of the present invention (Example 1 of method for forming positive electrode active material) is described with reference to FIG. 1A to FIG. 1D.

First, lithium cobalt oxide is prepared as a starting material in Step S10. The particle diameter (strictly, median diameter (D50)) of the lithium cobalt oxide that is a starting material can be less than or equal to 10 μm (preferably less than or equal to 8 μm). Note that unless otherwise specified, in this specification and the like, the median diameter refers to D50 (a particle diameter at which cumulative frequency is 50%). Lithium cobalt oxide with a median diameter (D50) of less than or equal to 10 μm may be known or official (in short, commercially available) lithium cobalt oxide or lithium cobalt oxide formed through Step S11 to Step S14 shown FIG. 1B. As a typical example of the commercially available lithium cobalt oxide with a median diameter (D50) of less than or equal to 10 μm, lithium cobalt oxide manufactured by NIPPON CHEMICAL INDUSTRIAL CO., LTD. (product name: CELLSEED C-5H) can be given. The lithium cobalt oxide manufactured by NIPPON CHEMICAL INDUSTRIAL CO., LTD. (product name: CELLSEED C-5H) has a median diameter (D50) of approximately 7 μm. A method for forming lithium cobalt oxide with a median diameter (D50) of less than or equal to 10 μm through Step S11 to Step S14 is described below.

### <Step S11>

In Step S11 shown in FIG. 1B, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, tricobalt tetraoxide, cobalt hydroxide, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and increased reliability can be obtained.

Furthermore, the cobalt source preferably has high crystallinity, and preferably includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

### <Step S12>

Next, in Step S12 shown in FIG. 1B, the lithium source and the cobalt source are ground and mixed to form a mixed material. The grinding and mixing can be performed by a dry method or a wet method. To obtain lithium cobalt oxide with a median diameter (D50) of less than or equal to 10 μm as a starting material, the grinding and mixing by a wet method are preferred because a material can be ground into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used.

In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used as a means for the grinding and mixing, for example. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, the mixed material is heated in Step S13 shown in FIG. 1B. The heating is preferably performed at higher than or equal to 800° C. and lower than or equal to 1100° C., further preferably at higher than or equal to 900° C. and lower than or equal to 1000° C., still further preferably at approximately 950° C. and lower than or equal to 1000° C. An excessively low temperature might lead to insufficient decomposition and melting of the lithium source and the transition metal source. An excessively high temperature might lead to a defect due to evaporation of lithium from the lithium source and/or excessive reduction of cobalt, for example. For example, an oxygen defect which could be induced by a change of trivalent cobalt into divalent cobalt.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours, still further preferably longer than or equal to 2 hours and shorter than or equal to 10 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container used at the time of the heating is preferably a crucible or a sagger made of aluminum oxide. The crucible made of aluminum oxide has a material property that hardly allows the entry of impurities. In this embodiment, a sagger made of aluminum oxide with a purity of 99.9% is used. Note that the heating is preferably performed with the crucible or the sagger covered with a lid, in which case volatilization of a material can be prevented.

The heated material is ground as needed and may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized in Step S14 in FIG. 1B. The lithium cobalt oxide (LiCoO₂) in Step S14 is an oxide containing a plurality of metal elements in its structure and thus can be referred to as a composite oxide. Note that the lithium cobalt oxide (LiCoO₂) shown in Step S14 may be obtained after adjusting particle size distribution by performing a grinding step and a classification step after Step S13.

Although the example is described in which the composite oxide is formed by a solid phase method as in Step S11 to Step S14, the composite oxide may be formed by a coprecipitation method. Alternatively, the composite oxide may be formed by a hydrothermal method.

Through Step S11 to Step S14, lithium cobalt oxide that is a starting material for a positive electrode active material applicable to a lithium ion battery having excellent discharge characteristics even in a low-temperature environment can be obtained. Specifically, as the lithium cobalt oxide that is a starting material, lithium cobalt oxide with a median diameter (D50) of less than or equal to 10 μm can be obtained.

### <Step S15>

Next, as Step S15 shown in FIG. 1A, the lithium cobalt oxide that is a starting material is heated. The heating in Step S15 is the first heating performed on the lithium cobalt oxide and thus is sometimes referred to as the initial heating in this specification and the like. The heating is performed before Step S31 described below, and thus is sometimes referred to as preheating or pretreatment.

By the initial heating, a lithium compound or the like unintentionally remaining on a surface of lithium cobalt oxide is extracted. In addition, an effect of increasing the crystallinity of the inner portion can be expected. Although the lithium source and/or the cobalt source prepared in Step S11 and the like might contain impurities, impurities in the lithium cobalt oxide that is a starting material can be reduced by the initial heating. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. Furthermore, through the initial heating, an effect of reducing a crack, a crystal defect, or the like included in the lithium cobalt oxide is obtained. In this specification and the like, a smooth surface refers to a state of having little unevenness and being rounded as a whole, and its corner portion is rounded. A smooth surface also refers to a surface to which few foreign matters are attached. Foreign matters are deemed to cause unevenness and are preferably not attached to a surface.

For the initial heating, a lithium compound source, an additive element A source, or a material functioning as a fusing agent is not necessarily separately prepared.

When the heating time in this step is too short, a sufficient effect is not obtained, but when the heating time in this step is too long, the productivity is lowered. For example, as an appropriate range of the heating time, any of the heating conditions described for Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and an inner portion of the above lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, Step S15 can reduce the differential shrinkage caused in the lithium cobalt oxide and make the surface of the composite oxide smooth.

Such differential shrinkage might cause a micro shift in the lithium cobalt oxide such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

In a secondary battery including lithium cobalt oxide with a smooth surface as a positive electrode active material, deterioration by charge and discharge is suppressed and a crack in the positive electrode active material can be prevented.

Note that pre-synthesized lithium cobalt oxide with a median diameter (D50) of less than or equal to 10 μm may be used in Step S10 as described above. In that case, Step S11 to Step S13 can be omitted. When Step S15 is performed on the pre-synthesized lithium cobalt oxide, lithium cobalt oxide with a smooth surface can be obtained.

Note that Step S15 is not essential in one embodiment of the present invention; thus, an embodiment in which Step S15 is skipped is also included in one embodiment of the present invention.

### <Step S20>

Next, details of Step S20 of preparing the additive element A as the A source are described with reference to FIG. 1C and FIG. 1D.

### <Step S21>

Step S20 shown in FIG. 1C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. Alternatively, one or more selected from bromine and beryllium can be used. FIG. 1C shows an example of the case where a magnesium source (Mg source) and a fluorine source (F source) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 and the neighborhood thereof). Note that in this specification and the like, the expression “an approximate value of a given value” means greater than 0.9 times and less than 1.1 times the given value, unless otherwise specified.

### <Step S22>

Next, in Step S22 shown in FIG. 1C, the magnesium source and the fluorine source are ground and mixed. Any of the conditions for grinding and mixing that are described for Step S12 can be selected to perform this step.

### <Step S23>

Next, in Step S23 shown in FIG. 1C, the materials ground and mixed in the above step are collected to give the additive element A source (A source). Note that the additive element A source in Step S23 contains a plurality of starting materials and can be referred to as a mixture.

As for the particle diameter of the mixture, the median diameter (D50) is preferably greater than or equal to 100 nm and less than or equal to 10 μm, further preferably greater than or equal to 300 nm and less than or equal to 5 μm. Also when one kind of material is used as the additive element A source, the median diameter (D50) is preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion of the composite oxide after heating.

### <Step S21>

A process different from that in FIG. 1C is described with reference to FIG. 1D. Step S20 shown in FIG. 1D includes Step S21 to Step S23.

In Step S21 shown in FIG. 1D, four kinds of additive element A sources to be added to the lithium cobalt oxide are prepared. In other words, FIG. 1D is different from FIG. 1C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (Al source) are prepared. The magnesium source and the fluorine source can be selected from the compounds and the like described with reference to FIG. 1C. As a nickel source, nickel oxide, nickel hydroxide, or the like can be used. As an aluminum source, aluminum oxide, aluminum hydroxide, or the like can be used.

### <Step S22 and Step S23>

Next, Step S22 and Step S23 shown in FIG. 1D are similar to Step S22 and Step S23 shown in FIG. 1C.

### <Step S31>

Next, in Step S31 shown in FIG. 1A, the lithium cobalt oxide that has been subjected to Step S15 (initial heating) and the additive element A source (Mg source) are mixed. Here, the atomic ratio of cobalt Co in the lithium cobalt oxide that has been subjected to Step S15 to magnesium Mg contained in the additive element A is preferably Co:Mg=100:y (0.1≤y≤6), further preferably Co:Mg=100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide that has been subjected to Step S15.

The condition of the mixing in Step S31 is preferably milder than that of the grinding and mixing in Step S12 not to damage the lithium cobalt oxide shape. For example, a condition with a smaller number of rotations or a shorter time than that of the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 1A, the materials mixed in the above step are collected, whereby a mixture 903 is obtained. At the time of the collection, the materials may be crushed as needed and made to pass through a sieve.

### <Step S33>

Then, in Step S33 shown in FIG. 1A, the mixture 903 is heated. The heating in Step S33 is preferably performed at higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in lithium cobalt oxide and the additive element A source occurs, and may be lower than the melting temperatures of these materials. In the case where an oxide is described as an example, solid phase diffusion occurs at the Tamman temperature T_{d} (0.757 times the melting temperature Tₘ); thus, the heating temperature in Step S33 is higher than or equal to 500° C.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and fabrication of the positive electrode active material having favorable characteristics.

Since LiF in a gas phase has a specific gravity less than that of oxygen, heating might volatilize or sublimate LiF and in that case, LiF in the mixture 903 decreases. In this case, the function of a fusing agent deteriorates. Therefore, heating is preferably performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903. The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

Uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

### <Step S34>

Next, the heated material is collected in Step S34 shown in FIG. 1A, in which crushing is performed as needed; thus, a positive electrode active material 100 is obtained. Here, the collected positive electrode active material 100 is preferably made to pass through a sieve. Through the above process, the positive electrode active material 100 (composite oxide) with a median diameter (D50) of less than or equal to 12 μm (preferably less than or equal to 10.5 μm, further preferably less than or equal to 8 μm) can be formed. Note that the positive electrode active material 100 contains the additive element A.

### <Example 2 of Method for Forming Positive Electrode Active Material>

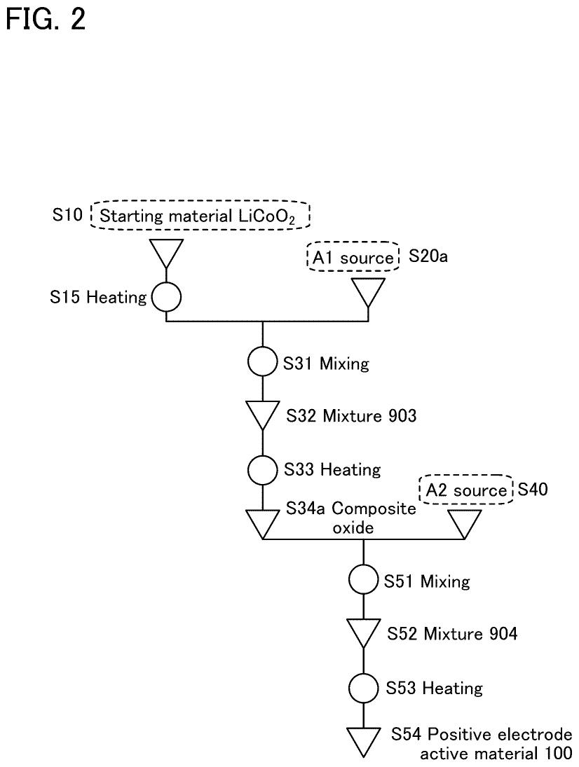

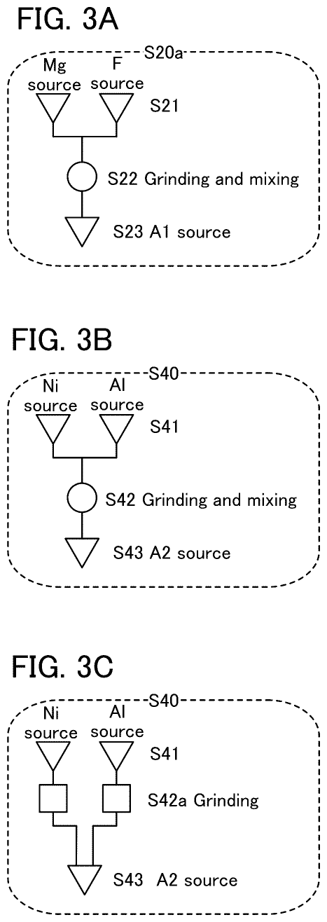

Another example of a method for forming the positive electrode active material that can be used as one embodiment of the present invention (Example 2 of method for forming positive electrode active material) is described with reference to FIG. 2 and FIG. 3. Although Example 2 of method for forming positive electrode active material is different from Example 1 of method for forming positive electrode active material described above in the number of times of adding the additive element and a mixing method, for the description except for the above, the description of Example 1 of method for forming positive electrode active material can be referred to.

Step S10 to Step S15 in FIG. 2 are performed as in FIG. 1A to prepare lithium cobalt oxide that has been subjected to the initial heating. Note that Step S15 is not essential in one embodiment of the present invention: thus, an embodiment in which Step S15 is skipped is also included in one embodiment of the present invention.

### <Step S20a>

Next, as shown in Step S20a, a first additive element A1 source (A1 source) is prepared. Step S20a is described in detail with reference to FIG. 3A.

### <Step S21>

In Step S21 shown in FIG. 3A, a first additive element A1 source (A1 source) is prepared. The A1 source can be selected from the additive elements A described for Step S21 shown in FIG. 1C to be used. For example, one or more selected from magnesium, fluorine, and calcium can be used as the additive element A1. FIG. 3A shows an example of the case where a magnesium source (Mg source) and a fluorine source (F source) are used as the additive element A1.

Step S21 to Step S23 shown in FIG. 3A can be performed under the same conditions as those in Step S21 to Step S23 shown in FIG. 1C. As a result, the first additive element Al source (A1 source) can be obtained in Step S23.

Steps S31 to S33 shown in FIG. 2 can be performed under the same conditions as those in Steps S31 to S33 shown in FIG. 1A.

### <Step S34a>

Next, the material heated in Step S33 is collected to obtain lithium cobalt oxide containing the additive element A1. Here, the composite oxide is called a second composite oxide to be distinguished from the lithium cobalt oxide that has been subjected to Step S15 (first composite oxide).

### <Step S40>

In Step S40 shown in FIG. 2, a second additive element A2 source (A2 source) is prepared. Step S40 is described with reference to FIG. 3B and FIG. 3C.

### <Step S41>

In Step S40 shown in FIG. 3B, a second additive element A2 source (A2 source) is prepared. The A2 source can be selected from the additive elements A described for Step S20 shown in FIG. 1C. For example, one or more selected from nickel, titanium, boron, zirconium, and aluminum can be suitably used as the additive element A2. FIG. 3B shows an example of the case where a nickel source and an aluminum source are used as the additive element A2.

Step S41 to Step S43 shown in FIG. 3B can be performed under the same conditions as those in Step S21 to Step S23 shown in FIG. 1C. As a result, the second additive element A2 source (A2 source) can be obtained in Step S43.

FIG. 3C showing Step S41 to Step S43 is a variation example of FIG. 3B. A nickel source (Ni source) and an aluminum source (A1 source) are prepared in Step S41 shown in FIG. 3C and are separately ground in Step S42a. Accordingly, a plurality of the second additive element A2 sources (A2 sources) are prepared in Step S43. As described above, Step S40 in FIG. 3C is different from Step S40 in FIG. 3B in that the additive elements are separately ground in Step S42a.

### <Step S51 to Step S53>

Next, Step S51 to Step S53 shown in FIG. 2 can be performed under the same conditions as those in Step S31 to Step S33 shown in FIG. 1A. The heating in Step S53 is preferably performed at a lower temperature and/or in a shorter time than the heating in Step S33 shown in FIG. 2. Specifically, the heating temperature is preferably higher than or equal to 800° C. and lower than or equal to 950° C., further preferably at higher than or equal to 820° C. and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the second additive element A2, the mixing in Step S51 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide that has been subjected to Step S15.

### <Step S54>

Next, the heated material is collected in Step S54 shown in FIG. 2, in which crushing is performed as needed; thus, the positive electrode active material 100 is obtained. Through the above process, the positive electrode active material 100 (composite oxide) with a median diameter (D50) of less than or equal to 12 μm (preferably less than or equal to 10.5 μm, further preferably less than or equal to 8 μm) can be formed. Alternatively, the positive electrode active material 100 applicable to a lithium ion battery having excellent discharge characteristics even in a low-temperature environment can be formed. Note that the positive electrode active material 100 contains the first additive element A1 and the second additive element A2.

In the example 2 of a formation method described above, as shown in FIG. 2 and FIG. 3, introduction of the additive element to the lithium cobalt oxide is divided into introduction of the first additive element A1 and that of the second additive element A2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion. The positive electrode active material 100 formed through the steps in FIG. 1A and FIG. 1D has an advantage of being formed at low cost since a plurality of kinds of additive elements A are added at the same time. Meanwhile, although the formation cost of the positive electrode active material 100 formed through FIG. 2 and FIG. 3 is relatively high since a plurality of kinds of additive elements A are added in a plurality of steps, a profile of each of the additive elements A in the depth direction can be accurately controlled, which is preferable.

### Embodiment 2

### [Lithium Ion Battery]

A lithium ion battery that can be formed as one embodiment of the present invention includes a positive electrode, a negative electrode, and an electrolyte. When the electrolyte includes an electrolyte solution, a separator is provided between the positive electrode and the negative electrode. An exterior body covering at least part of peripheries of the positive electrode, the negative electrode, and the electrolyte may be further included.

In this embodiment, description is made focusing on a structure of a lithium ion battery which is needed to provide a lithium ion battery with excellent discharge characteristics even in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.) and/or a lithium ion battery with excellent charge characteristics even in a low-temperature environment. Specifically, a positive electrode active material that is contained in a positive electrode and an electrolyte are mainly described. A detailed structure of the lithium ion battery, other than a positive electrode active material and an electrolyte, will be described in Embodiment 3.

### [Positive Electrode]

A positive electrode includes a positive electrode active material layer and a positive electrode current collector. The positive electrode active material layer contains a positive electrode active material and may further contain at least one of a conductive material and a binder.

### <Positive Electrode Active Material>

The positive electrode active material has functions of taking and/or releasing lithium ions in accordance with charge and discharge. For a positive electrode active material used as one embodiment of the present invention, a material with less deterioration (or a material with slight increase in resistance) due to charge and/or discharge (hereinafter, also called “charge and discharge”) in a low-temperature environment even at high charge voltage can be used. Specifically, a positive electrode active material (composite oxide) with a particle diameter (strictly, median diameter (D50)) of less than or equal to 12 μm (preferably less than or equal to 10.5 μm, further preferably less than or equal to 8 μm) obtained by the formation method described in Embodiment 1 can be used. This positive electrode active material contains the additive element A, or the first additive element A1 and the second additive element A2.

Note that when the particle diameter of the positive electrode active material is too small, application might be difficult to perform in the formation of the positive electrode. Alternatively, when the particle diameter of the positive electrode active material is too small, the surface area becomes too large, which might cause an excessive side reaction between a positive electrode active material surface and the electrolyte solution. Alternatively, when the particle diameter of the positive electrode active material is too small, a large amount of conductive material functioning as a conduction path between particles needs to be mixed, which might lead to a decrease in capacity. Accordingly, the particle diameter (median diameter (D50)) of the positive electrode active material is preferably larger than or equal to 1 μm.

In this specification and the like, unless otherwise specified, a “charge voltage” is shown with reference to the potential of a lithium metal. In this specification and the like, high charge voltage is a charge voltage, for example, higher than or equal to 4.6 V, preferably higher than or equal to 4.65 V. further preferably higher than or equal to 4.7 V, still further preferably higher than or equal to 4.75 V, and the most preferably higher than or equal to 4.8 V. Note that for the positive electrode active material, two or more kinds of materials having different particle diameters and/or compositions can be used as long as the materials have less deterioration due to charge and discharge even at high charge voltages. In this specification and the like, the term “having different compositions” includes not only the case where the elements contained in the materials have different compositions but also the case where the ratios of the elements contained in the materials are different even though the elements contained in the materials have the same composition.

As described above, “high charge voltage” in this specification and the like is the voltage higher than or equal to 4.6 V with reference to the potential when a lithium metal is used for the negative electrode; however, “high charge voltage” is the voltage higher than or equal to 4.5 V with reference to the potential when a carbon material (e.g., graphite) is used for the negative electrode. In short, the charge voltage higher than or equal to 4.6 V is referred to as high charge voltage in the case of using a lithium metal as the negative electrode in a half cell, and the charge voltage higher than or equal to 4.5 V is referred to as high charge voltage in the case of using a carbon material (e.g., graphite) for the negative electrode in a full cell.

Even when the charge voltage is high, a material with less deterioration (or a material with slight increase in resistance) due to charge and discharge in a low-temperature environment (e.g., 0° C., −20° C., preferably −30° C., further preferably −40° C., still further preferably −50° C., most preferably −60° C.) is used as the positive electrode active material, whereby a lithium ion battery with high discharge capacity even in a low-temperature environment can be obtained. Alternatively, a lithium ion battery can be obtained in which a discharge capacity value in a low-temperature environment (e.g., 0° C., −20° C., preferably −30° C., further preferably −40° C., still further preferably −50° C., most preferably −60° C.) is higher than or equal to 50% (preferably higher than or equal to 60%, further preferably higher than or equal to 70%, still further preferably higher than or equal to 80%, most preferably higher than or equal to 90%) of a discharge capacity value at 25° C. Note that conditions for measuring the discharge capacity value in a low-temperature environment and the discharge capacity value at 25° C. are the same, other than the temperature at the time of discharge (hereinafter, also referred to as “discharge temperature” in this specification and the like).

Alternatively, use of such a material enables a lithium ion battery with a high discharge energy density even in a low-temperature environment (e.g., 0° C., −20° C., preferably −30° C., further preferably −40° C., still further preferably −50° C., most preferably −60° C.). Alternatively, a lithium ion battery can be obtained in which a discharge energy density value in a low-temperature environment (e.g., 0° C., −20° C., preferably −30° C., further preferably −40° C., still further preferably −50° C., most preferably −60° C.) is higher than or equal to 50% (preferably higher than or equal to 60%, further preferably higher than or equal to 70%, still further preferably higher than or equal to 80%, most preferably higher than or equal to 90%) of a discharge energy density value at 25° C. Note that conditions for measuring the discharge energy density value in a low-temperature environment and the discharge energy density value at 25° C. are the same, other than the temperature at the time of discharge.

The temperature at the time of charge or discharge described in this specification and the like refer to the temperatures of a lithium ion battery. In the measurement of the battery characteristics at a variety of temperatures, for example, a thermostatic chamber that is stable at desired temperature is used, a battery (e.g., a test battery or a half cell) that is a target of the measurement is installed in the thermostatic chamber, and then the measurement can start after sufficient time (e.g., 1 hour or longer) break until the temperature of the test cell is substantially equal to that of the thermostatic chamber. The method is not necessarily limited thereto.

### <Electrolyte>

For the electrolyte used as one embodiment of the present invention, a material with high lithium ion conductivity in charge and/or discharge (charge and discharge) even in a low-temperature environment (e.g., 0° C., −20° C., preferably −30° C., further preferably −40° C., still further preferably −50° C., most preferably −60° C.) can be used.

An example of an electrolyte is described below. Note that the electrolyte described in this embodiment as an example is an organic solvent in which a lithium salt is dissolved and can also be referred to as an electrolyte solution. The electrolyte is not limited to a liquid electrolyte (electrolyte solution) that is liquid at room temperature, and a solid electrolyte can be used as well. Alternatively, an electrolyte including both a liquid electrolyte that is liquid at room temperature and a solid electrolyte that is a solid at room temperature (such an electrolyte is referred to as a semi-solid electrolyte) can also be used.

For example, an organic solvent described in this embodiment contains ethylene carbonate (EC), ethyl methyl carbonate (EMC), and dimethyl carbonate (DMC). When a total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100−x−y (where 5≤x≤35 and 0<y<65) can be used. More specifically, an organic solvent containing EC, EMC, and DMC at EC:EMC:DMC=30:35:35 (volume ratio) can be used. Note that the volume ratio may be a volume ratio of the organic solvent before mixing, and the organic solvent may be mixed at room temperature (typically 25° C.).

EC is cyclic carbonate and has high dielectric constant, and thus has an effect of promoting dissociation of a lithium salt. Meanwhile, the EC has high viscosity and has a high freezing point (melting point) of 38° C.; thus, it is difficult to use in a low-temperature environment when EC is used alone as the organic solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, and the freezing point is −43° C. An electrolyte solution formed using a mixed organic solvent in a volume ratio of x:y:100−x−y (note that 5≤x≤35 and 0<y<65) with a total content of these three organic solvents of EC, EMC, and DMC having such physical properties of 100 vol % has a characteristic in which the freezing point is lower than or equal to −40° C.

A general electrolyte used for a lithium ion battery is solidified at approximately −20° C.; thus, it is difficult to fabricate a battery that can be charged and discharged at −40° C. Since the electrolyte described as an example in this embodiment has a freezing point lower than or equal to −40° C., a lithium ion battery that can be charged and discharged even in an extremely low-temperature environment such as at −40° C. can be obtained.

For example, as the lithium salt dissolved in the solvent, at least one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis (oxalate) borate (LiBOB) can be used, or two or more of these lithium salts can be used in an appropriate combination with an appropriate ratio.

The electrolyte is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis (oxalate) borate (LiBOB), or a dinitrile compound such as succinonitrile or adiponitrile may be added to the electrolyte. The concentration of such an additive agent in the organic solvent is, for example, higher than or equal to 0.1 wt % and lower than or equal to 5 wt %.

Although an example of an electrolyte that can be used for the lithium ion battery of one embodiment of the present invention is described above, the electrolyte that can be used for the lithium ion battery of one embodiment of the present invention should not be construed as being limited to the example. Another material can be used as long as it has high lithium ion conductivity even when charge and discharge are performed in a low-temperature environment.

The lithium ion battery of one embodiment of the present invention includes at least the above positive electrode active material and the above electrolyte, thereby achieving excellent discharge characteristics and/or excellent charge characteristics even in a low-temperature environment. More specifically, the following lithium ion battery can be achieved. At least the above positive electrode active material and the above electrolyte are included; and when a test battery is formed using a lithium metal as a negative electrode, a discharge capacity value of the test battery obtained by, after performing constant current charge at a charge rate of 0.1 C or 0.2 C (where 1 C=200 mA/g) until a voltage reaches 4.6 V in an environment of 25° C., performing constant current discharge at a discharge rate of 0.1 C until a voltage reaches 2.5 V in an environment of −40° C. is higher than or equal to 50% of a discharge capacity value of the test battery obtained by, after performing constant current charge at a charge rate of 0.1 C or 0.2 C (where 1 C=200 mA/g) until a voltage reaches 4.6 V in an environment of 25° C., performing constant current discharge at a discharge rate of 0.1 C until a voltage reaches 2.5 V in an environment of 25° C. In this specification and the like, when the discharge capacity in an environment of T° C. (T is given temperature other than 25° C. (C)) can be higher than or equal to 50% of the discharge capacity in an environment of 25° C., it can be said that the lithium ion battery can be operated at T° C.

The contents of this embodiment can be freely combined with the contents of the other embodiments.

### Embodiment 3

In this embodiment, components included in a lithium ion battery are described.

### [Positive Electrode]

A positive electrode includes a positive electrode active material layer and a positive electrode current collector. The positive electrode active material layer includes a positive electrode active material and may further contain at least one of a conductive material and a binder. As the positive electrode active material, the positive electrode active material described in Embodiment 1 can be used.

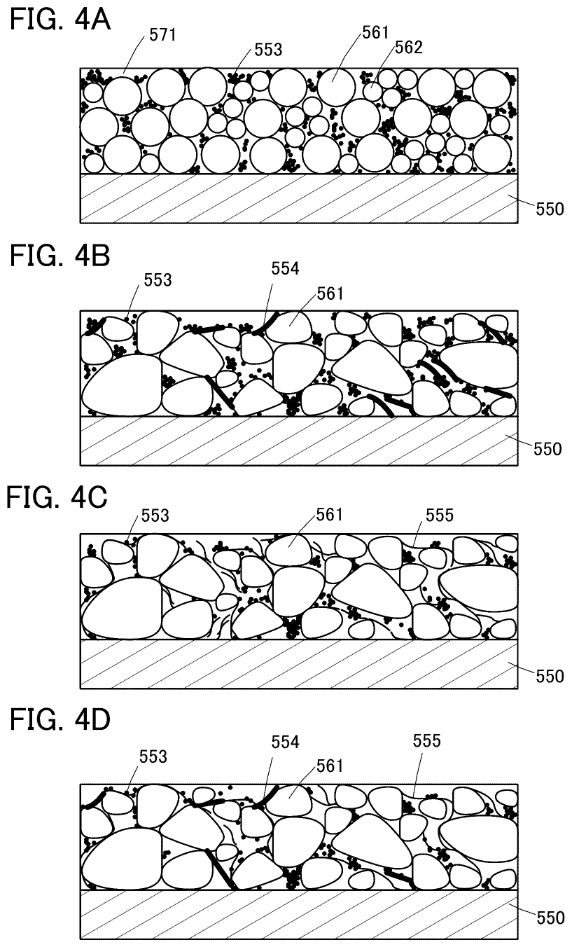

FIG. 4A illustrates an example of a schematic cross-sectional view of the positive electrode.

Metal foil can be used as a current collector 550, for example. The positive electrode can be formed by applying slurry onto the metal foil and drying the slurry. Note that pressing may be performed after drying. The positive electrode is a component obtained by forming an active material layer over the current collector 550.

Slurry refers to a material solution that is used to form an active material layer over the current collector 550 and includes an active material, a binder, and a solvent, preferably also a conductive material mixed therewith. Slurry may also be referred to as slurry for an electrode or active material slurry: in some cases, slurry for forming a positive electrode active material layer is referred to as slurry for a positive electrode, and slurry for forming a negative electrode active material layer is referred to as slurry for a negative electrode.

A positive electrode active material 561 has functions of taking and/or releasing lithium ions in accordance with charge and discharge. For the positive electrode active material 561 used as one embodiment of the present invention, a material with less deterioration due to charge and discharge even at high charge voltage can be used. In this specification and the like, unless otherwise specified, a charge voltage is shown with reference to the potential of a lithium metal. In this specification and the like, high charge voltage is a charge voltage, for example, higher than or equal to 4.6 V, preferably higher than or equal to 4.65 V, further preferably higher than or equal to 4.7 V, still further preferably higher than or equal to 4.75 V, and the most preferably higher than or equal to 4.8 V.

For the positive electrode active material 561 used as one embodiment of the present invention, any material can be used as long as it has less deterioration due to charge and discharge even at high charge voltage, and any of the materials described in Embodiment 1 or Embodiment 2 can be used. Note that for the positive electrode active material 561, two or more kinds of materials having different particle diameters can be used as long as the materials have less deterioration due to charge and discharge even at high charge voltage.

A conductive material is also referred to as a conductivity-imparting agent or a conductive additive, and a carbon material can be used as the conductive material. A conductive material is attached between a plurality of active materials, whereby the plurality of active materials are electrically connected to each other, and the conductivity increases. Note that in this specification and the like, the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive additive are electrically connected to each other without being in contact with each other.

Specific examples of carbon materials that can be used as the conductive material include carbon black (e.g., furnace black, acetylene black, or graphite).

FIG. 4A illustrates a carbon black 553, which is an example of a conductive material, and an electrolyte 571, which is included in a space portion positioned between the positive electrode active materials 561.

In the positive electrode of the secondary battery, a binder (a resin) may be mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of binder mixed is preferably reduced to a minimum. In FIG. 4A, the region not filled with the positive electrode active material 561, a second positive electrode active material 562, or the carbon black 553 indicates a space or a binder.

Although FIG. 4A shows an example in which the positive electrode active material 561 has a spherical shape, there is no particular limitation and other various shapes can be employed.

The cross-sectional shape of the positive electrode active material 561 may be an ellipse, a rectangle, a trapezoid, a pyramid, a polygon with rounded corners, or an asymmetrical shape, for example. For example, FIG. 4B illustrates an example in which the positive electrode active material 561 has a polygon shape with rounded corners.

In the positive electrode in FIG. 4B, graphene 554 is used as a carbon material used as the conductive material. In FIG. 4B, a positive electrode active material layer including the positive electrode active material 561, the graphene 554, and the carbon black 553 is formed over the current collector 550.

In the step of mixing the graphene 554 and the carbon black 553 to obtain an electrode slurry, the weight of mixed carbon black is preferably 1.5 times to 20 times, further preferably 2 times to 9.5 times the weight of graphene.

When the graphene 554 and the carbon black 553 are mixed in the above range, the carbon black 553 is excellent in dispersion stability and an aggregated portion is unlikely to be generated at the time of preparing a slurry. Furthermore, when the graphene 554 and the carbon black 553 are mixed in the above range, the electrode density can be higher than that of a positive electrode using only the carbon black 553 as a conductive material. As the electrode density is higher, the capacity per unit weight can be higher. Specifically, the density of the positive electrode active material layer measured by gravimetry can be higher than or equal to 3.5 g/cc.

The electrode density is lower than that of a positive electrode containing only graphene as a conductive material, but when a first carbon material (graphene) and a second carbon material (acetylene black) are mixed in the above range, fast charge can be achieved. Thus, use of such a mixed conductive additive for secondary batteries for vehicles is particularly effective.

FIG. 4C shows an example of a positive electrode in which carbon fiber 555 is used instead of graphene. FIG. 4C illustrates an example different from FIG. 4B. With use of the carbon fiber 555, aggregation of carbon black 553 can be prevented and the dispersibility can be increased.

In FIG. 4C, the region that is not filled with the first positive electrode active material 561, the carbon fiber 555, or the carbon black 553 represents a space or a binder.

FIG. 4D illustrates another example of a positive electrode. FIG. 4C shows an example in which the carbon fiber 555 is used in addition to the graphene 554. With use of both the graphene 554 and the carbon fiber 555, aggregation of carbon black such as the carbon black 553 can be prevented and the dispersibility can be further increased.

In FIG. 4D, the region that is not filled with the first positive electrode active material 561, the carbon fiber 555, the graphene 554, or the carbon black 553 indicates a space or a binder.

A secondary battery can be manufactured by using any one of the positive electrodes in FIG. 4A to FIG. 4D; setting, in a container (e.g., an exterior body or a metal can) or the like, a stack in which a separator is provided over the positive electrode and a negative electrode is provided over the separator; and filling the container with an electrolyte solution.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly (methyl acrylate), poly (methyl methacry late) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide or, for instance, a cellulose derivative such as carboxymethyl cellulose (CMC), methyl cellulose, ethyl cellulose, hydroxypropyl cellulose, diacetyl cellulose, or regenerated cellulose and starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Positive Electrode Current Collector>

The positive electrode current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material, and may further contain a conductive material and a binder.

### <Negative Electrode Active Material>

As a negative electrode active material, for example, an alloy-based material or a carbon material can be used.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying and a dealloying reaction with lithium and a compound containing the element, for example, are referred to as alloy-based materials in some cases.

In this specification and the like, SiO refers, for example, to silicon monoxide. Alternatively, SiO can be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium ion battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be contained in the negative electrode active material layer, materials similar to those of the conductive material and the binder that can be contained in the positive electrode active material layer can be used.

### <Negative Electrode Current Collector>

For the negative electrode current collector, copper or the like can be used in addition to a material similar to that of the positive electrode current collector. Note that a material that is not alloyed with carrier ions of lithium or the like is preferably used for the negative electrode current collector.

### [Electrolyte]

As the electrolyte, any of the electrolytes described in Embodiment 1 can be used.

### [Separator]

When the electrolyte includes an electrolyte solution, a separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Embodiment 4

In this embodiment, examples of the shape of a secondary battery including the positive electrode formed by the formation method described in the above embodiment are described.

### [Coin-Type Secondary Battery]

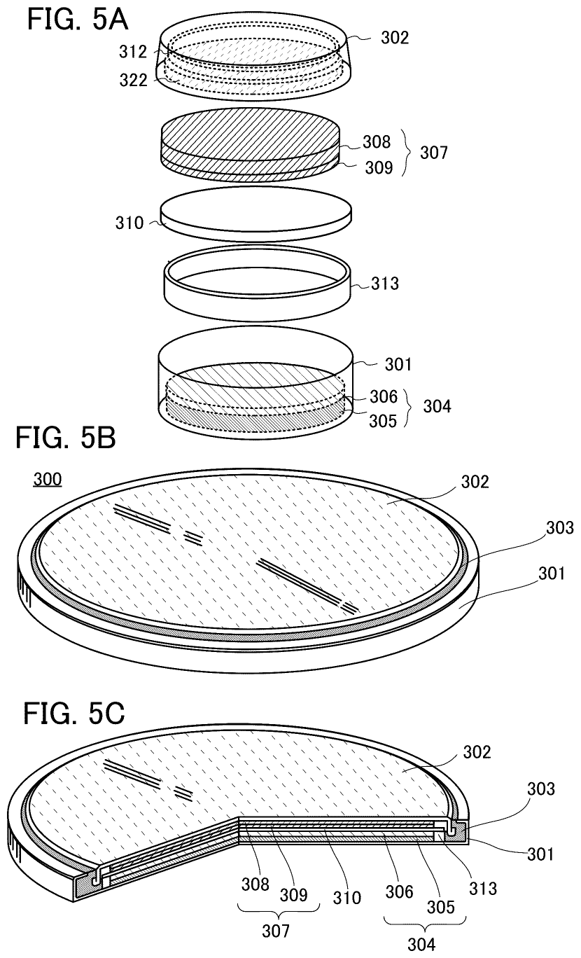

An example of a coin-type secondary battery is described. FIG. 5A is an exploded perspective view of a coin-type (single-layer flat type) secondary battery, FIG. 5B is an external view thereof, and FIG. 5C is a cross-sectional view thereof. Coin-type secondary batteries are mainly used in small electronic devices.

For easy understanding, FIG. 5A is a schematic view illustrating overlap (a vertical relation and a positional relation) between components. Thus, FIG. 5A and FIG. 5B do not completely correspond with each other.

In FIG. 5A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 5A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 5B is a perspective view of a completed coin-type secondary battery.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 5C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high capacity, high charge and discharge capacity, and excellent cycle performance.

### [Cylindrical Secondary Battery]

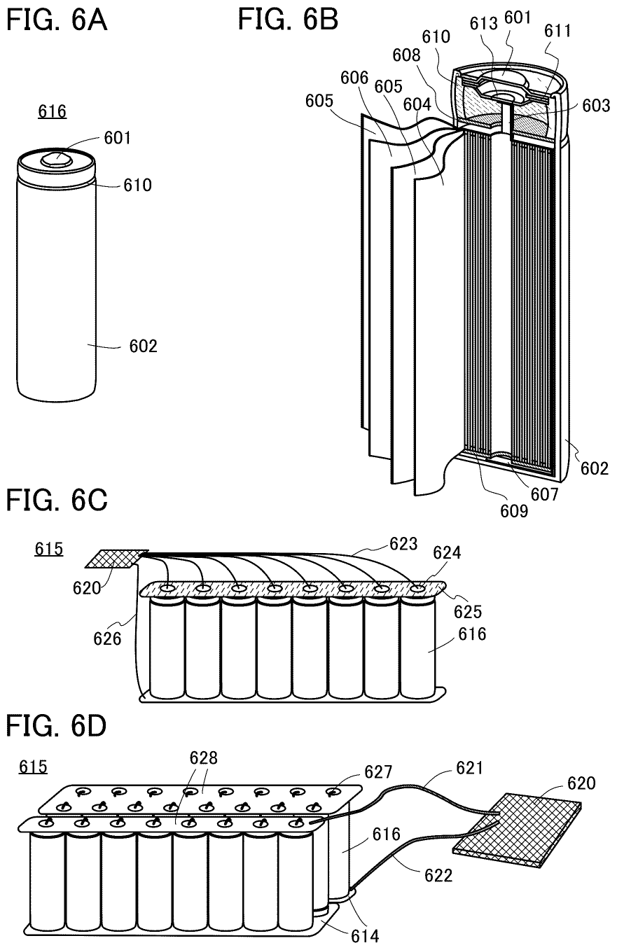

An example of a cylindrical secondary battery is described with reference to FIG. 6A. As illustrated in FIG. 6A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 6B schematically illustrates a cross section of a cylindrical secondary battery. The cylindrical secondary battery illustrated in FIG. 6B includes the positive electrode cap (battery cap) 601 on the top surface and the battery can (outer can) 602 on the side surface and bottom surface. The positive electrode cap 601 and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not shown) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector.

The positive electrode active material 100 obtained in Embodiments 1, 2, and the like is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 6C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit for performing charge, discharge, and the like or a protection circuit for preventing overcharge and/or overdischarge can be used.

FIG. 6D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 6D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

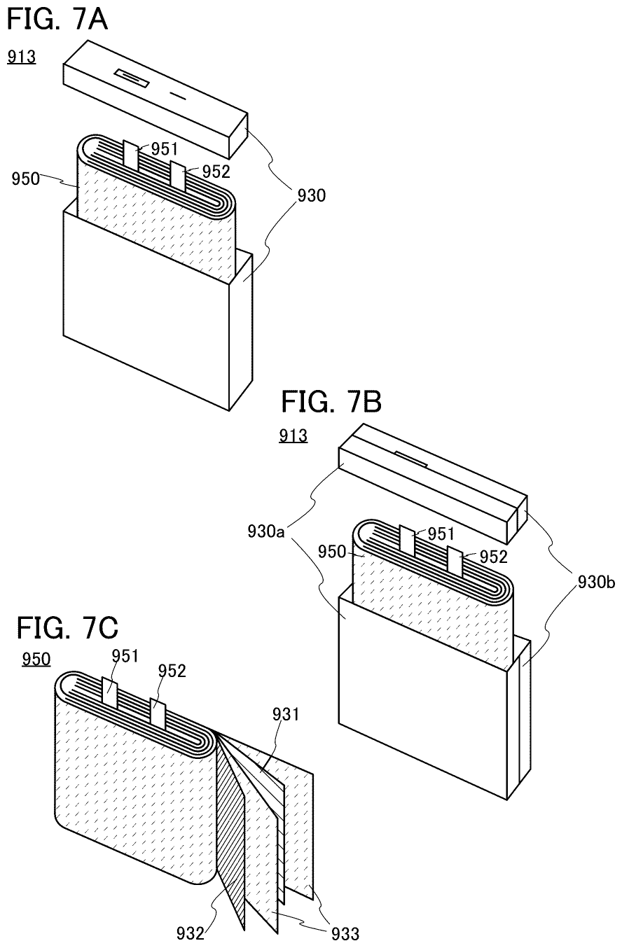

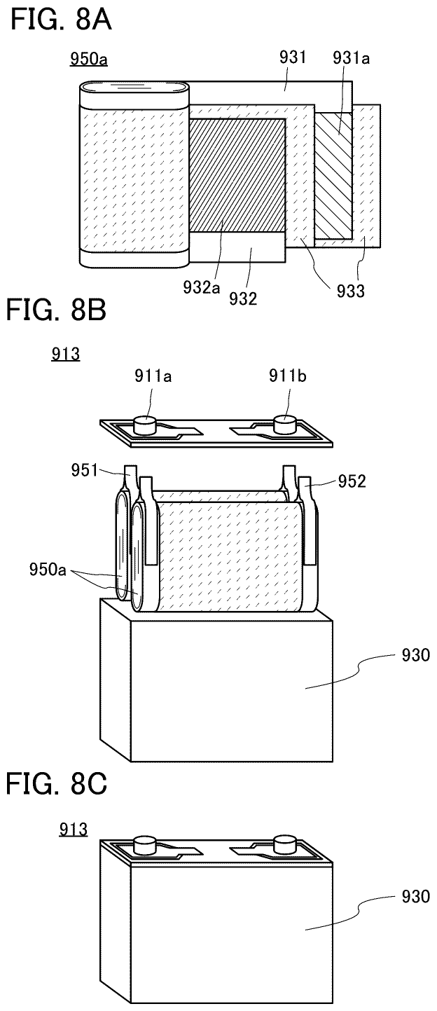

Structure examples of secondary batteries are described with reference to FIG. 7 and FIG. 8.

A secondary battery 913 illustrated in FIG. 7A includes a wound body 950 provided with a terminal 951 and a terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 7A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 7B, the housing 930 in FIG. 7A may be formed using a plurality of materials. For example, in the secondary battery 913 illustrated in FIG. 7B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 7C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 8, the secondary battery 913 may include a wound body 950a. The wound body 950a illustrated in FIG. 8A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiments 1, 2, and the like is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 8B, the negative electrode 931 is electrically connected to a terminal 951 by ultrasonic bonding, welding, or pressure bonding. The terminal 951 is electrically connected to a terminal 911a. The positive electrode 932 is electrically connected to a terminal 952 by ultrasonic bonding, welding, or pressure bonding. The terminal 952 is electrically connected to a terminal 911b.

As illustrated in FIG. 8C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 8B, the secondary battery 913 may include a plurality of wound bodies 950a. The use of the plurality of wound bodies 950a enables the secondary battery 913 to have higher discharge capacity. The description of the secondary battery 913 illustrated in FIG. 7A to FIG. 7C can be referred to for the other components of the secondary battery 913 illustrated in FIG. 8A and FIG. 8B.

### <Laminated Secondary Battery>

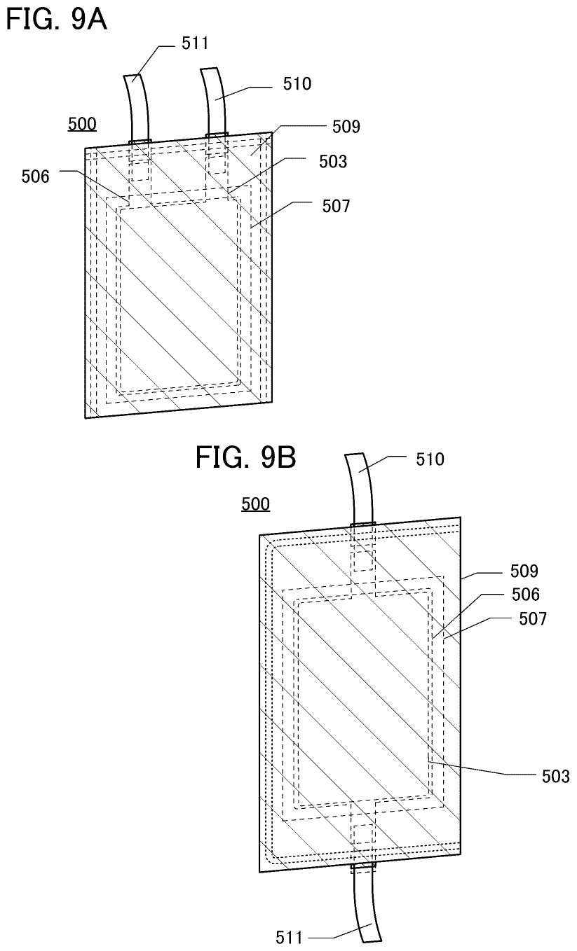

Next, examples of the appearance of a laminated secondary battery are illustrated in FIG. 9A and FIG. 9B. FIG. 9A and FIG. 9B each include a positive electrode 503, a negative electrode 506, a separator 507, an exterior body 509, a positive electrode lead electrode 510, and a negative electrode lead electrode 511.

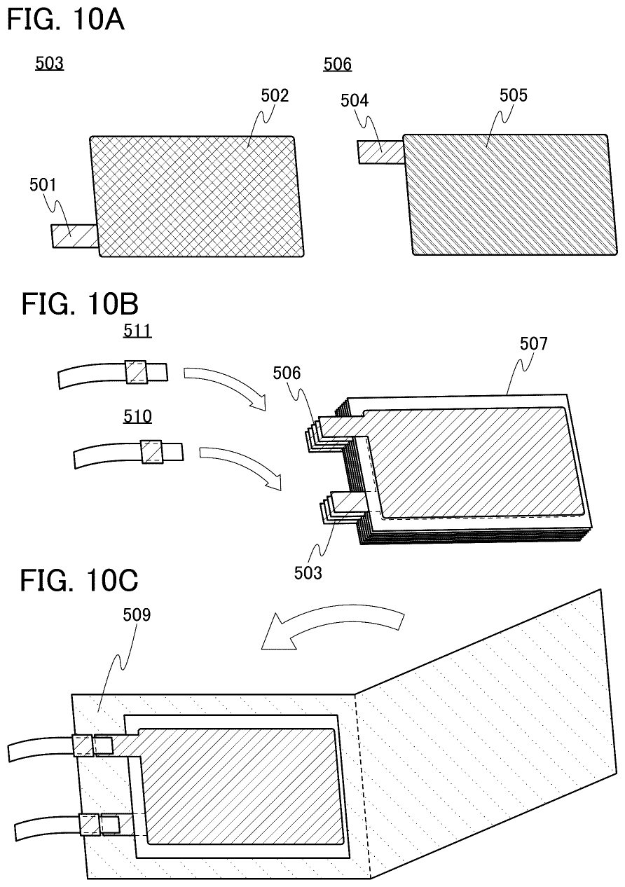

FIG. 10A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to the examples shown in FIG. 10A.

### <Fabrication Method of Laminated Secondary Battery>

An example of a method for fabricating the laminated secondary battery whose external view is illustrated in FIG. 9A is described with reference to FIG. 10B and FIG. 10C.

First, the negative electrode 506, the separator 507, and the positive electrode 503 are stacked. FIG. 10B illustrates the negative electrodes 506, the separators 507, and the positive electrodes 503 that are stacked. Here, an example in which five negative electrodes and four positive electrodes are used is shown. The stacked negative electrodes, separators, and positive electrodes can be referred to as a stack. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 10C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 obtained in Embodiments 1, 2, and the like is used for the positive electrode 503, whereby the secondary battery 500 can have high capacity, high charge and discharge capacity, and excellent cycle performance.

### [Examples of Battery Pack]

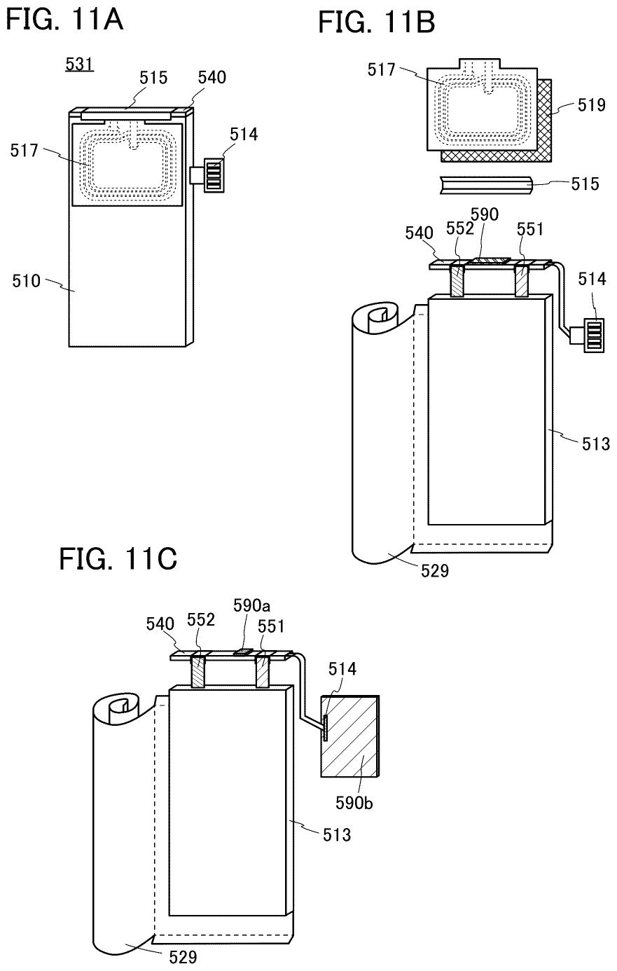

Examples of a secondary battery pack of one embodiment of the present invention that is capable of wireless charging using an antenna is described with reference to FIG. 11.

FIG. 11A is a diagram illustrating the appearance of a secondary battery pack 531 that has a rectangular solid shape with a small thickness (also referred to as a flat plate shape with a certain thickness). FIG. 11B illustrates a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 11B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 11C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### Embodiment 5

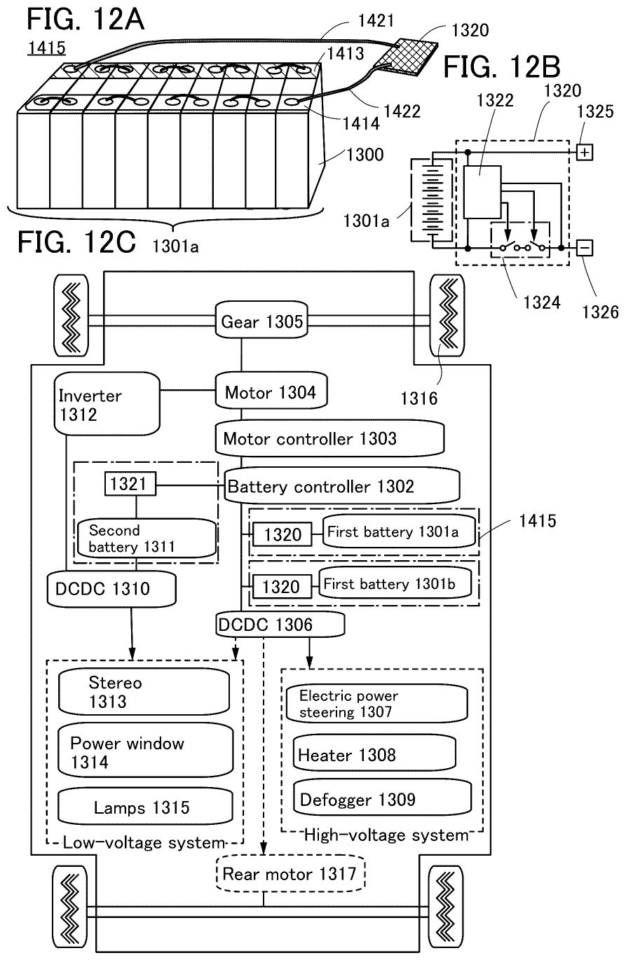

In this embodiment, an example different from the cylindrical secondary battery in FIG. 6D is described. An example of application to an electric vehicle (EV) is described with reference to FIG. 12C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 7C or FIG. 8A or the stacked-layer structure illustrated in FIG. 9A or FIG. 9B. Alternatively, an all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

Next, the first battery 1301a is described with reference to FIG. 12A.

FIG. 12A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 or a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In-Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is not easily observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Iₒₙ), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery including a positive electrode using the positive electrode active material 100 obtained in Embodiments 1, 2, and the like, the synergy on safety can be obtained. The secondary battery whose positive electrode uses the positive electrode active material 100 obtained in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of a secondary battery include prevention of overcharge, prevention of overcurrent, control of overheating during charging, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charge and discharge are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charge and discharge performed a plurality of times cause a non-uniform distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 12B shows an example of a block diagram of the battery pack 1415 illustrated in FIG. 12A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and/or overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium ion batteries in that they have a larger amount of self-discharge and are more likely to deteriorate due to a phenomenon called sulfation. There is an advantage that the second battery 1311 can be maintenance-free when a lithium ion battery is used; however, in the case of long-term use, for example three years or more, anomaly that is difficult to determine at the time of fabrication might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging. The battery controller 1302 can set the charge voltage, charge current, and the like of the first batteries 1301a and 1301b. The battery controller 1302 can set charge conditions in accordance with charge characteristics of a secondary battery to be used, so that fast charge can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 KW, for example. Furthermore, charge can be performed with electric power supplied from external charge equipment by a contactless power feeding method or the like.

For fast charge, secondary batteries that can withstand high-voltage charge have been desired to perform charge in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the positive electrode active material 100 described in Embodiments 1, 2, and the like can increase the operating voltage of the secondary battery, and the increase in charge voltage can increase the available capacity. Moreover, using the positive electrode active material 100 described in Embodiments 1, 2, and the like in the positive electrode can provide an automotive secondary battery having excellent cycle performance.

Next, examples in which the secondary battery of one embodiment of the present invention is mounted on a vehicle, typically a transport vehicle, are described.

Mounting the secondary battery illustrated in any of FIG. 6D, FIG. 8C, and FIG. 12A on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

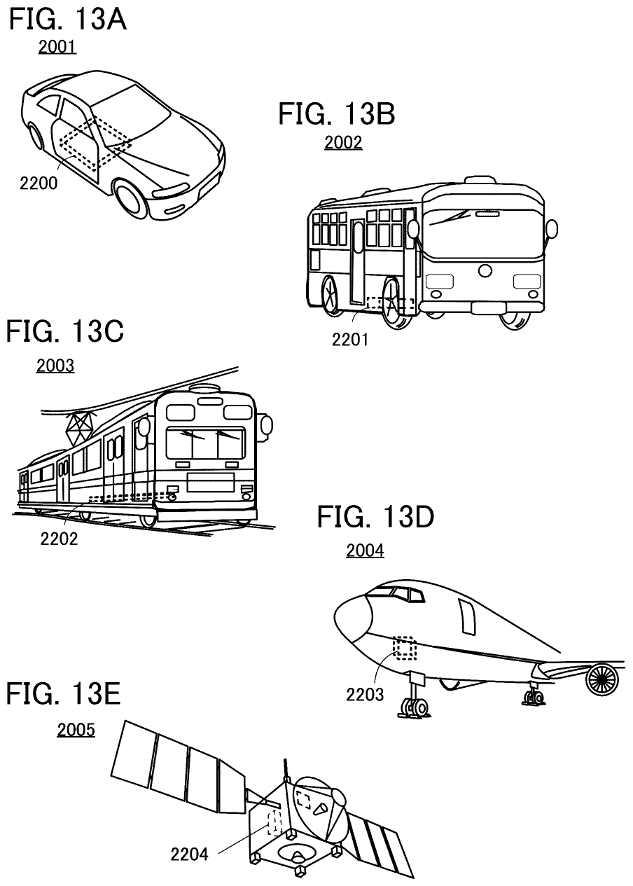

FIG. 13A to FIG. 13D illustrate examples of transport vehicles using one embodiment of the present invention. An automobile 2001 illustrated in FIG. 13A is an electric vehicle that runs using an electric motor as a driving power source. Alternatively, the automobile 2001 is a hybrid vehicle that enables appropriate selection of an electric motor or an engine as a driving power source. In the case where the secondary battery is mounted on the vehicle, an example of the secondary battery described in Embodiment 4 is provided at one position or several positions. The automobile 2001 illustrated in FIG. 13A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. The secondary battery may be a charge station provided in a commerce facility or a household power supply. For example, with use of the plug-in system, the power storage device mounted on the automobile 2001 can be charged by being supplied with electric power from the outside. Charge can be performed by converting AC power into DC power through a converter such as an ACDC converter.

Although not shown, the vehicle may include a power receiving device so that it can be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 13B illustrates a large transporter 2002 having a motor controlled by electricity as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 13A except, for example, the number of secondary batteries configuring the secondary battery module; thus, the description is omitted.

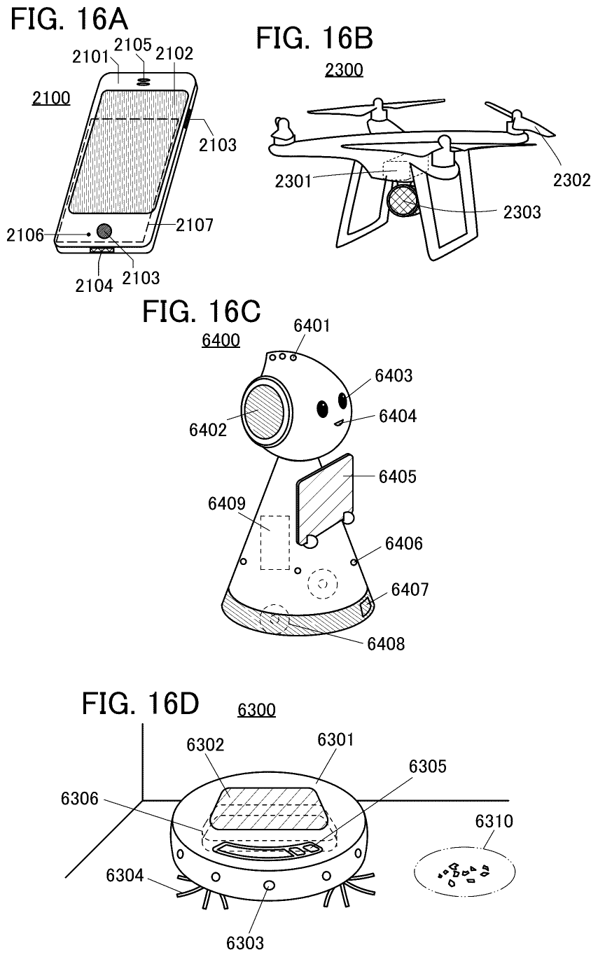

FIG. 13C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in the characteristics. By employing the positive electrode active material 100 described in Embodiments 1, 2, and the like for the positive electrode, a secondary battery having stable battery characteristics can be manufactured and mass production at low cost is possible in light of the yield. A battery pack 2202 has the same function as that in FIG. 16A except, for example, the number of secondary batteries configuring the secondary battery module; thus, the description is omitted.

FIG. 13D illustrates an aircraft 2004 having a combustion engine as an example. The aircraft 2004 illustrated in FIG. 13D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 13A except, for example, the number of secondary batteries configuring the secondary battery module; thus, the description is omitted.

FIG. 13E illustrates an artificial satellite 2005 including a secondary battery 2204 as an example. Because the artificial satellite 2005 is used in an ultra-low-temperature cosmic space, the secondary battery 2204 having excellent low temperature resistance of one embodiment of the present invention is preferably provided. It is further preferable that the secondary battery 2204 be mounted inside the artificial satellite 2005 while being covered with a heat-retaining member.

### Embodiment 6

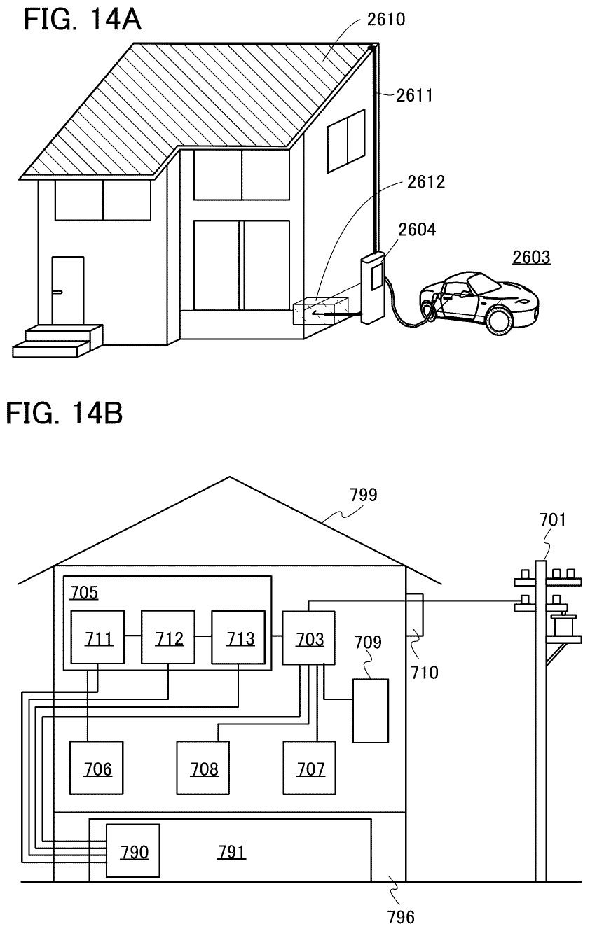

In this embodiment, examples in which the secondary battery of one embodiment of the present invention is mounted on a building will be described with reference to FIG. 14A and FIG. 14B.

A house illustrated in FIG. 14A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 14B illustrates an example of a power storage device of one embodiment of the present invention. As illustrated in FIG. 14B, a power storage device 791 of one embodiment of the present invention is provided in an underfloor space 796 of a building 799. The power storage device 791 may be provided with the control circuit described in Embodiment 7, and when a secondary battery including the positive electrode active material 100 obtained in Embodiments 1, 2, and the like for a positive electrode is used for the power storage device 791, the synergy on safety can be obtained. The secondary battery including the control circuit described in Embodiment 7 and a positive electrode using the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

### Embodiment 7

In this embodiment, examples in which a motorcycle and a bicycle are each provided with the power storage device of one embodiment of the present invention will be described.

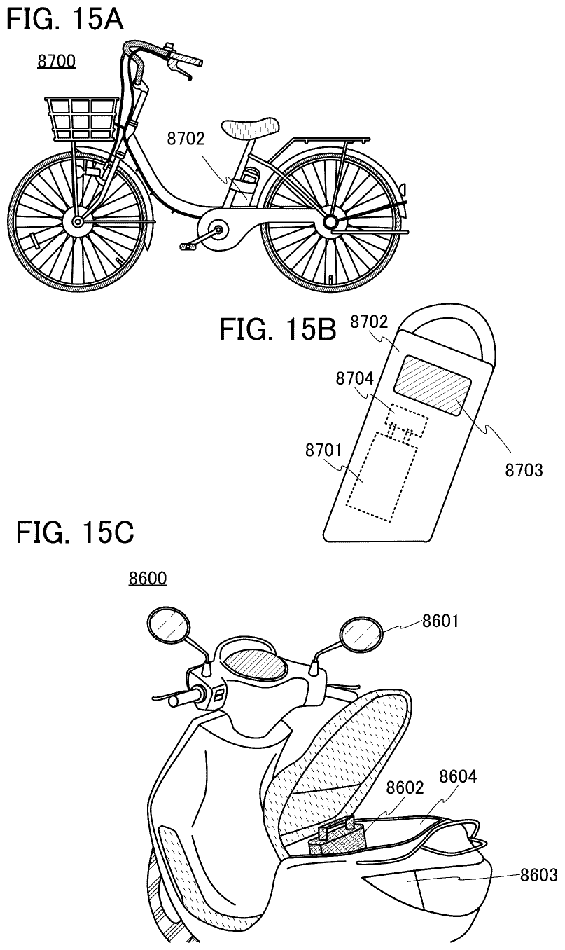

FIG. 15A illustrates an example of an electric bicycle using the power storage device of one embodiment of the present invention. The power storage device of one embodiment of the present invention can be used for an electric bicycle 8700 illustrated in FIG. 15A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 15B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 7. The control circuit 8704 is electrically connected to a positive electrode and a negative electrode of the storage battery 8701. When the control circuit 8704 is used in combination with a secondary battery including a positive electrode using the positive electrode active material 100 obtained in Embodiments 1, 2, and the like, the synergy on safety can be obtained. The secondary battery including a positive electrode using the positive electrode active material 100 obtained in Embodiments 1, 2, and the like and the control circuit 8704 can contribute greatly to elimination of accidents due to secondary batteries, such as fires.

FIG. 15C illustrates an example of a motorcycle using the power storage device of one embodiment of the present invention. A motor scooter 8600 illustrated in FIG. 15C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiments 1, 2, and the like can have high capacity and contribute to a reduction in size.

In the motor scooter 8600 illustrated in FIG. 15C, the power storage device 8602 can be stored in an under-seat storage unit 8604. The power storage device 8602 can be stored in the under-seat storage unit 8604 even when the under-seat storage unit 8604 is small.

### Embodiment 8

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

FIG. 16A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in Embodiments 1, 2, and the like achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 16B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiments 1, 2, and the like has high energy density and a high level of safety, and thus can be used safely for a long time over a long period of time and is preferable as the secondary battery included in the unmanned aircraft 2300.

FIG. 16C illustrates an example of a robot. A robot 6400 illustrated in FIG. 16C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6409 included in the robot 6400.

FIG. 16D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiments 1, 2, and the like has high energy density and a high level of safety, and thus can be used safely for a long time over a long period of time and is preferable as the secondary battery 6306 included in the cleaning robot 6300.

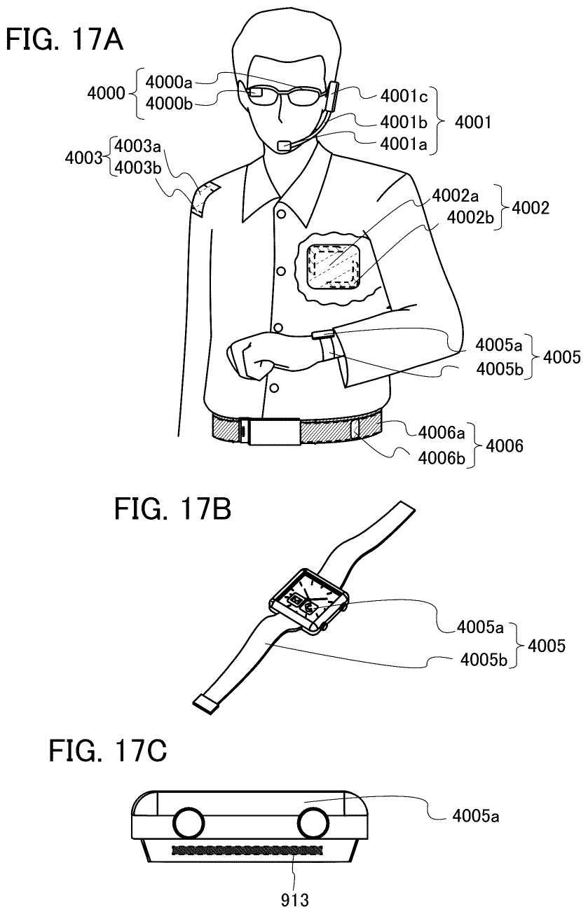

FIG. 17A illustrates examples of wearable devices. A secondary battery is used as a power supply of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 17A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiments 1, 2, and the like has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiments 1, 2, and the like has high energy density and achieves a structure that accommodates space saving due to a reduction in size of the housing.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 17B illustrates a perspective view of the watch-type device 4005 that is detached from an arm.

FIG. 17C illustrates a side view. FIG. 17C illustrates a state where the secondary battery 913 is incorporated in the inner region. The secondary battery 913 is the secondary battery described in Embodiment 4. The secondary battery 913 is provided to overlap with the display portion 4005a, can have high density and high capacity, and is small and lightweight.

Since the secondary battery in the watch-type device 4005 is required to be small and lightweight, the use of the positive electrode active material 100 obtained in Embodiments 1, 2, and the like in the positive electrode of the secondary battery 913 enables the secondary battery 913 to have high energy density and a small size.

### Example 1

### <Method for Forming Sample 1>

This example explains that the positive electrode active material 100 (Sample 1) with a median diameter (D50) of less than or equal to 12 μm can be obtained based on the description in Embodiment 1 and FIG. 2 to FIG. 3, and the like.

As lithium cobalt oxide (LiCoO₂) that was a starting material shown in Step S10 in FIG. 2, commercially available lithium cobalt oxide containing no additive element (CELLSEED C-5H produced by NIPPON CHEMICAL INDUSTRIAL CO., LTD.) was prepared. Hereinafter, in this specification and the like, the lithium cobalt oxide is simply referred to as “C-5H”. The median diameter (D50) of C-5H is approximately 7.0 μm, which satisfies the condition where the median diameter (D50) is less than or equal to 10 μm.

Next, the heating in Step S15 was performed on C-5H, which was put in a sagger (container) covered with a lid, in a muffle furnace at 850° C. for 2 hours. After the muffle furnace was filled with an oxygen atmosphere, no flowing was performed (O₂ purging). Note that C-5H was put in the sagger so that the powder had a height (also referred to as bulk) of less than or equal to 10 mm and was flat in the sagger.

Next, in accordance with Step S20a shown in FIG. 3A, the first additive element A1 source was formed. First, lithium fluoride (LiF) and magnesium fluoride (MgF₂) were prepared as the F source and the Mg source, respectively. LiF and MgF₂ were weighed such that LiF:MgF₂ was 1:3 (molar ratio). Then, LiF and MgF₂ were mixed in dehydrated acetone and the mixture was stirred at a rotating speed of 400 rpm for 12 hours. In the mixing, a ball mill was used and a grinding medium was zirconium oxide balls. LiF and MgF₂ weighing approximately 10 g in total were put in a 45-mL-capacity container of the mixing ball mill together with 20 mL of dehydrated acetone and 22 g of zirconium oxide balls (1 mmϕ) and mixed. Then, the mixture was made to pass through a sieve with an aperture of 300 μm, whereby the first additive element A1 source was obtained.

Next, in accordance with Step S31 shown in FIG. 2, the lithium cobalt oxide (lithium cobalt oxide subjected to the initial heating) obtained by the heating in Step S15 and the first additive element A1 source obtained in Step S20a were mixed. Specifically, approximately 9 g in total of the additive element A1 was weighed such that the additive element A1 was 1 mol % with respect to the lithium cobalt oxide, and then the lithium cobalt oxide after the initial heating and the first additive element A1 source were mixed by a dry method. At this time, stirring was performed at a rotating speed of 150 rpm for 1 hour. After that, the mixture was made to pass through a sieve with an aperture of 300 μm, whereby a mixture 903 was obtained (Step S32).

Next, as Step S33, the mixture 903 was heated. The heating conditions were 900° C. and 5 hours. During the heating, a lid was put on a sagger containing the mixture 903. The sagger was filled with an atmosphere containing oxygen and entry and exit of the oxygen were blocked (purged). By the heating, a composite oxide containing Mg and F (lithium cobalt oxide containing Mg and F) was obtained (Step S34a).

Next, in accordance with Step S40 shown in FIG. 3C, the second additive element A2 source was formed. First, nickel hydroxide (Ni(OH)₂) and aluminum hydroxide (Al(OH)₃) were prepared as the Ni source and the Al source, respectively. Next, the nickel hydroxide and the aluminum hydroxide were separately stirred in dehydrated acetone at a rotating speed of 400 rpm for 12 hours. In the mixing, a ball mill was used and a grinding medium was zirconium oxide balls. Into a 45-mL-capacity container were put 20 mL of dehydrated acetone, 22 g of zirconium oxide balls (1 mmϕ), and approximately 10 g of nickel hydroxide, and stirring was performed. Similarly, into a 45-mL-capacity container were put 20 mL of dehydrated acetone, 22 g of zirconium oxide balls (1 mmϕ), and approximately 10 g of aluminum hydroxide, and stirring was performed. Then, each of the nickel hydroxide and the aluminum hydroxide were made to pass through a sieve with an aperture of 300 μm, whereby the second additive element A2 source was obtained.

Next, in Step S51, the composite oxide containing Mg and F and the second additive element A2 source were mixed by a dry method. Specifically, the mixing was performed by 1-hour stirring at a rotating speed of 150 rpm. The mixture ratio was set so that each of the nickel hydroxide and the aluminum hydroxide contained in the second additive element A2 source was 0.5 mol % with respect to the lithium cobalt oxide. In the mixing, a ball mill was used and a grinding medium was zirconium oxide balls. The Ni source, the Al source, and the composite oxide (lithium cobalt oxide containing Mg and F) obtained in Step S34 weighing approximately 7.5 g in total were put in a 45-mL-capacity container of the mixing ball mill together with 22 g of zirconium oxide balls (1 mmϕ) and mixed. Finally, the mixture was made to pass through a sieve with an aperture of 300 μm, whereby a mixture 904 was obtained (Step S52).

Next, as Step S53, the mixture 904 was heated. The heating conditions were 850° C. and 2 hours. During the heating, a lid was put on a sagger containing the mixture 904. The sagger was filled with an atmosphere containing oxygen and entry and exit of the oxygen were blocked (purged). By the heating, lithium cobalt oxide containing Mg, F, Ni, and Al (composite oxide) was obtained (Step S54). In this specification and the like, the lithium cobalt oxide containing Mg, F, Ni, and Al obtained in this example is hereinafter referred to as Sample 1 in some cases.

### <Median Diameter (D50) of Sample 1>

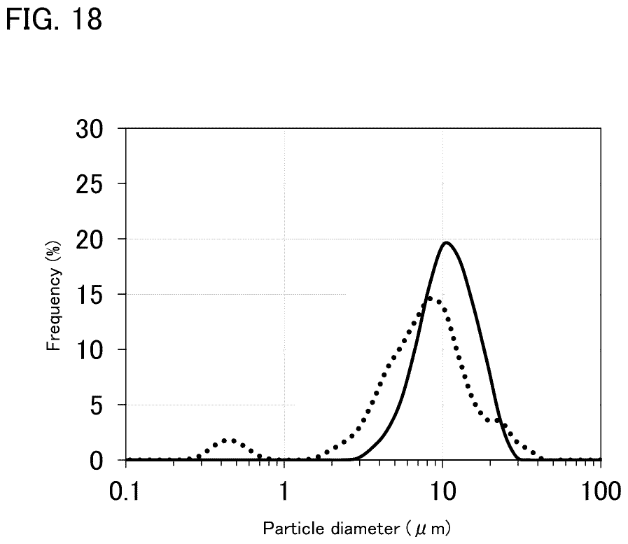

FIG. 18 shows particle size distribution of Sample 1 by a solid line. The median diameter (D50) of Sample 1 was approximately 9.7 μm. As a result, it was found that the median diameter (D50) of Sample 1 was less than or equal to 12 μm (less than or equal to 10.5 μm). Note that median diameter (D50) can be measured by observation using a SEM (scanning electron microscope) or a TEM or with a particle size distribution analyzer using a laser diffraction and scattering method, for example. In this example, a laser diffraction particle size analyzer SALD-2200 produced by Shimadzu Corporation was used for measurement.

Note that as reference example 1, a dotted line in FIG. 18 indicates particle size distribution of the commercially available lithium cobalt oxide containing no additive element (CELLSEED C-5H produced by NIPPON CHEMICAL INDUSTRIAL CO., LTD.), which was used as a starting material in this example. The median diameter (D50) of C-5H was approximately 7.0 μm.

### <SEM Observation of Sample 1 Surface>

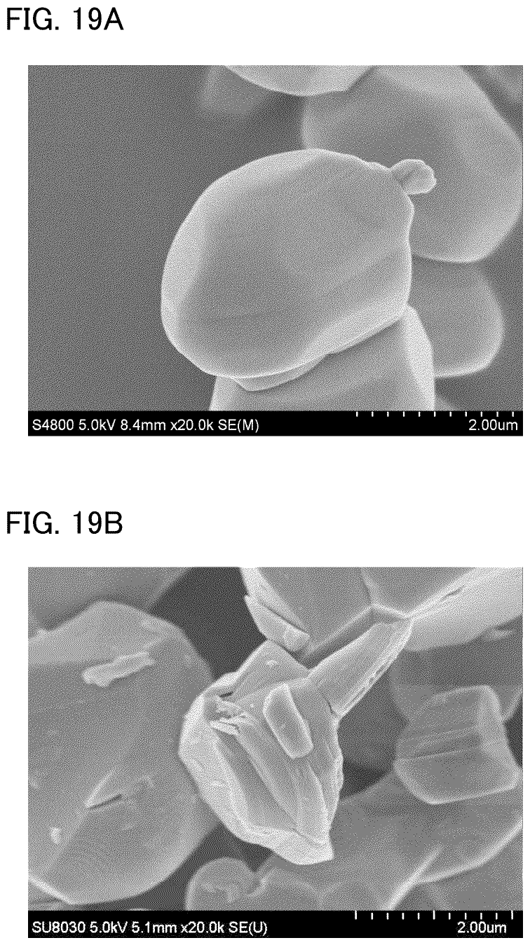

Next, FIG. 19A shows the results of SEM observation of Sample 1 (surface). FIG. 19B shows the results of SEM observation of the lithium cobalt oxide (C-5H) (surface) that is a starting material of Sample 1. In the SEM observation in this example, the measurement was performed using an S4800 scanning electron microscope produced by Hitachi High-Tech Corporation and an SU8030 scanning electron microscope produced by Hitachi High-Tech Corporation for FIG. 19A and FIG. 19B, respectively. As for the measurement conditions of each observation, an acceleration voltage was 5 kV and the magnification was 20000 times.

As shown in FIG. 19A, a state where the surface has extremely less unevenness is observed in Sample 1. Meanwhile, as shown in FIG. 19B, a state where the surface has extremely much unevenness is observed in the lithium cobalt oxide (C-5H), which is a starting material of Sample 1.

### Example 2

### <Formation of Half Cell Including Sample 1 as Positive Electrode Active Material>

In this example, formation conditions of coin-type half cells in each of which Sample 1 formed in Example 1 was used as a positive electrode active material are described. Note that a half cell 1 to a half cell 7 were formed under the same conditions to confirm the experimental reproducibility.

First, Sample 1, acetylene black (AB), and poly (vinylidene fluoride) (PVDF) were prepared as a positive electrode active material, a conductive material, and a binding agent, respectively. The PVDF prepared was one dissolved in N-methyl-2-pyrrolidone (NMP) with a weight ratio of 5%. A slurry was formed by mixing the positive electrode active material, AB, and PVDF at a weight ratio of 95:3:2, and the slurry was applied to a positive electrode current collector of aluminum. As a solvent of the slurry, NMP was used.

After the slurry was applied onto the positive electrode current collector, the solvent was volatilized.

After that, pressing treatment was performed with a roller press machine to increase the density of the positive electrode active material layer over the positive electrode current collector. The pressing treatment was performed with a linear pressure of 210 kN/m. Note that the temperature of each of an upper roll and a lower roll of the roller press machine was 120° C.

Through the above process, the positive electrode was obtained. In the positive electrode, the loading amount of the active material was approximately 7 mg/cm².

An electrolyte solution used for the half cell 1 to the half cell 7 contains an organic solvent. The organic solvent contains ethylene carbonate (EC), ethyl methyl carbonate (EMC), and dimethyl carbonate (DMC). When the total content of EC, EMC, and DMC was set to 100vol %, an organic solvent in which the volume ratio of EC, EMC, and DMC was x:y:100−x−y (note that 5≤x≤35 and 0<y<65) was used. More specifically, an organic solvent containing EC, EMC, and DMC at EC:EMC:DMC=30:35:35 in a volume ratio was prepared. A solution in which lithium hexafluorophosphate (LiPF₆) was dissolved in this organic solvent at a concentration of 1 mol/L was used as the electrolyte solution. Hereinafter, in this specification and the like, this electrolyte solution is referred to as an “electrolyte solution A”.

A general electrolyte solution used for a lithium ion battery is solidified at approximately −20° C.; thus, it is difficult to form a battery that can be charged and discharged at −40° C. The electrolyte solution used in this example has a freezing point at lower than or equal to −40° C., which is one of the conditions to achieve a lithium ion battery that can be charged and discharged even in an extremely low-temperature environment such as at −40° C.

As a separator, a polypropylene porous film was used. For a negative electrode (counter electrode), a lithium metal was used. They were used for forming coin-type half cells (the half cell 1 to the half cell 7). Note that the half cell 1 to the half cell 7 can be referred to as test batteries.

### Example 3

In this example, measurement results of the half cell 1 to the half cell 7 formed in Example 2 are described.

### <25° C. Discharge Capacity>

The discharge capacity at 25° C. was measured using the half cell 1. Charge was performed in the following manner: constant current charge was performed at current of 0.1 C (where 1 C=200 mA/g) until the voltage reached 4.60 V, and constant voltage charge was successively performed at 4.60 V until the charge current reached lower than or equal to 0.01 C. As the conditions at the time of discharge, constant current discharge was performed at a discharge rate of 0.1 C (where 1 C=200 mA/g) until 2.5 V (cutoff voltage) was reached.

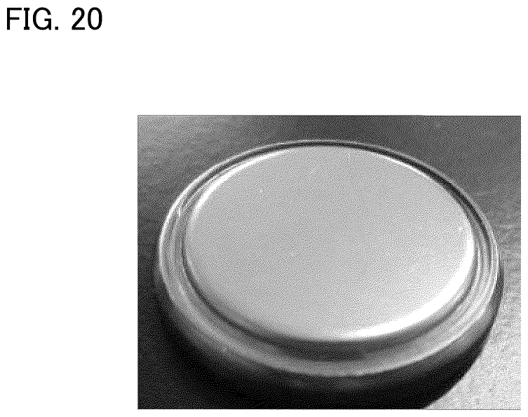

Charge and discharge were repeated three times on the half cell 1 to the half cell 7 under the above charge and discharge conditions. Table 1 shows the 0.1 C current value, the 25° C. discharge capacity (capacity of the third discharge), the positive electrode active material weight, and the discharge capacity (capacity of the third discharge) per weight of the positive electrode active material. FIG. 20 shows a photograph showing the appearance of the half cell 2.

TABLE 1

| | | | Positive | Discharge capacity |
|---|---|---|---|---|
| | 0.1 C | Discharge | electrode | per weight of positive |
| | current | capacity | active material | electrode active |
| | (mA) | (mAh) | weight (mg) | material (mAh/g) |
| Half cell 1 | 0.1412 | 1.522 | 7.05 | 216.0 |
| Half cell 2 | 0.1418 | 1.538 | 7.09 | 216.9 |
| Half cell 3 | 0.1442 | 1.564 | 7.21 | 217.0 |
| Half cell 4 | 0.1377 | 1.496 | 6.89 | 217.3 |
| Half cell 5 | 0.1422 | 1.545 | 7.11 | 217.3 |
| Half cell 6 | 0.1450 | 1.572 | 7.25 | 216.9 |
| Half cell 7 | 0.1341 | 1.437 | 6.69 | 214.8 |

### <Temperature Characteristics of Discharge Capacity>

Next, the temperature characteristics measured using the half cell 1 are described. The discharge capacity was measured using the half cell 1 under a plurality of temperature conditions after the measurement shown in Table 1. Four conditions of 25° C., 0° C., −20° C., and −40° C. were employed for the temperatures at the time of discharge, and charge at 25° C. was performed before each of the discharge tests at the above temperatures. Charge was performed in the following manner: constant current charge was performed at current of 0.1 C (where 1 C=200 mA/g) until the voltage reached 4.60 V, and constant voltage charge was successively performed at 4.60 V until the charge current reached lower than or equal to 0.01 C. The conditions at the time of discharge, except the temperature, were the same and were such that constant current discharge was performed at a discharge rate of 0.1 C (where 1 C=200 mA/g) until 2.5 V (cutoff voltage) was reached. Note that the temperature at the time of charge or discharge described in this example of this specification corresponds to the temperature of a constant temperature bath where the half cell was left for a certain period of time.

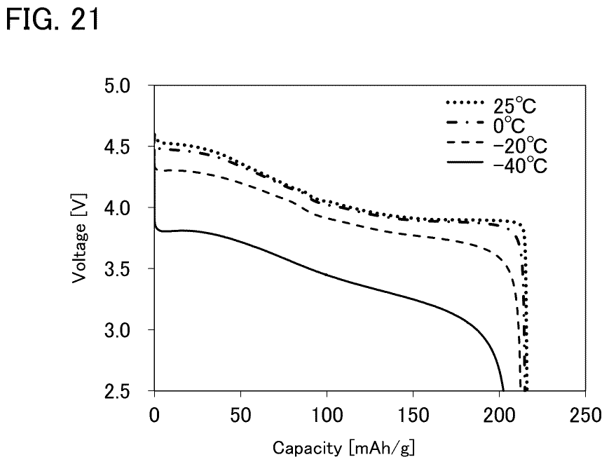

FIG. 21 shows discharge curves with respect to the temperatures at the time of discharge. As each of the discharge curves in FIG. 21, the dotted line represents a result when the temperature at a time of discharge was 25° C., the dashed-dotted line represents a result when the temperature at a time of discharge was 0° C., the dashed line represents a result when the temperature at a time of discharge was −20° C., and the solid line represents a result when the temperature at a time of discharge was −40° C. Table 2 shows measurement results of the discharge capacity, the average discharge voltage, and the discharge energy density at the temperatures at the time of discharge. Table 3 shows proportions (unit: %) of the discharge capacity, the average discharge voltage, and the discharge energy density normalized by dividing the values of the discharge capacity, the average discharge voltage, and the discharge energy density at the temperatures at the time of discharge by respective values when the temperature at a time of discharge was 25° C. Note that the discharge capacity (unit: mAh/g) in Table 2 is a value calculated per weight of the positive electrode active material. Furthermore, the discharge energy density (unit: mWh/g) in Table 2 is a value calculated by multiplying the discharge capacity by the average discharge voltage (unit: V).

TABLE 2

| | |
|---|---|
| Sample name | Half cell 1 |
| Positive electrode | LCO containing |
| active material | Mg, F, Ni, and Al |
| Charge voltage | 4.6 V |

| | | | |
|---|---|---|---|
| Discharge | 25° | C. | 216.0 |
| capacity | 0° | C. | 214.9 |
| [mAh/g] | −20° | C. | 212.3 |
| | −40° | C. | 202.4 |
| Average | 25° | C. | 4.11 |
| discharge | 0° | C. | 4.08 |
| voltage | −20° | C. | 3.94 |
| [V] | −40° | C. | 3.44 |
| Discharge | 25° | C. | 888.6 |
| energy | 0° | C. | 877.4 |
| density | −20° | C. | 835.7 |
| [mWh/g] | −40° | C. | 695.8 |

TABLE 3

| | |
|---|---|
| Sample name | Half cell 1 |
| Positive electrode | LCO containing |
| active material | Mg, F, Ni, and Al |
| Charge voltage | 4.6 V |

| | | | |
|---|---|---|---|
| Proportion of | 25° | C. | 100.0 |
| 25° C. normalized | 0° | C. | 99.5 |
| discharge capacity | −20° | C. | 98.3 |
| [%] | −40° | C. | 93.7 |
| Proportion of | 25° | C. | 100.0 |
| 25° C. normalized | 0° | C. | 99.3 |
| average discharge | −20° | C. | 95.7 |
| voltage [%] | −40° | C. | 83.6 |
| Proportion of | 25° | C. | 100.0 |
| 25° C. normalized | 0° | C. | 98.7 |
| discharge energy | −20° | C. | 94.0 |
| density [%] | −40° | C. | 78.3 |

As shown in FIG. 21, Table 2, and Table 3, extremely high discharge capacity is achieved under the condition of 0° C. and the condition of −20° C., and is substantially equal to the discharge capacity under the condition of 25° C. Specifically, the discharge capacity at 0° C. was 99.5% of the discharge capacity at 25° C., and the discharge capacity at −20° C. was 98.3% of the discharge capacity at 25° C. Furthermore, high discharge capacity was obtained also under the condition of −40° C. Specifically, it was demonstrated that the discharge capacity at −40° C. was 93.7% of the discharge capacity at 25° C. and discharge capacity that was greater than or equal to 90% of the discharge capacity at 25° C. was obtained even in an extremely low-temperature environment such as at −40° C.

According to the results shown in FIG. 21, Table 2, and Table 3, it was revealed that the lithium ion battery including the positive electrode active material obtained by the formation method described in Embodiment 1 and the like and the electrolyte solution A was able to operate at least in a range of temperature which was higher than or equal to −40° C. and lower than or equal to 25° C.

As shown in FIG. 21, Table 2, and Table 3, Sample 1 exhibited extremely high discharge capacity, greater than or equal to 200 mAh/g, even at a discharge temperature of −40° C. From another viewpoint, an excellent result was obtained in which the discharge capacity at the time of discharge at −40° C. was greater than or equal to 90% of the discharge capacity at the time of discharge at 25° C. From another viewpoint, the obtained discharge energy density at the time of discharge at −40° C. was high, approximately 700 mWh/g. From another viewpoint, the obtained result was such that the discharge energy density at the time of discharge at −40° C. was 78.3% of the discharge energy density at the time of discharge at 25° C. Accordingly, the following results were obtained: the discharge capacity at the time of discharge at −40° C. was greater than or equal to 200 mAh/g, the discharge capacity at the time of discharge at −40° C. was greater than or equal to 90% of the discharge capacity at the time of discharge at 25° C., the discharge energy density at the time of discharge at −40° C. is greater than or equal to 650 mAh/g, and the discharge energy density at the time of discharge at −40° C. was greater than or equal to 75% of the discharge energy density at the time of discharge at 25° C.

The lithium ion battery including Sample 1 as a positive electrode active material had extremely high discharge capacity even though discharged at a low temperature (i.e., in a low-temperature environment); thus, diffusion resistance of lithium ions in the composite oxide (positive electrode active material) of Sample 1 and the electrolyte solution A is estimated to be extremely low even in a low-temperature environment. From the above results, it was demonstrated that the positive electrode active material obtained by the formation method described in Embodiment 1 and the like and the electrolyte solution A were very useful as materials of a lithium ion battery used in a low-temperature environment (e.g., at −40° C.).

### <Charge and Discharge in Low-Temperature Environment>

Next, the discharge capacity temperature characteristics measured using the half cell 7 are described. In the measurement shown in FIG. 21, Table 2, and Table 3, charge was performed at 25° C., and discharge was performed under a plurality of temperature conditions; meanwhile, in this measurement, charge and discharge under the same temperature conditions were performed at a plurality of temperatures.

The charge and discharge conditions for the half cell 7 in a low-temperature environment are described. After the charge and discharge at 25° C. shown in Table 1, charge and discharge were performed under a plurality of temperature conditions in the following order: charge and discharge at 0° C., charge and discharge at 25° C., charge and discharge at −20° C., charge and discharge at 25° C., and charge and discharge at −40° C. As the charge and discharge conditions for each temperature condition, the charge was performed in the following manner: constant current charge was performed at current of 0.1 C until the voltage reached 4.60 V, and constant voltage charge was successively performed at 4.60 V until the current reached lower than or equal to 0.01 C. As the discharge condition, constant current discharge was performed at current of 0.1 C until 2.5 V (cutoff voltage) was reached. Note that, 1 C was set to 200 mA/g.

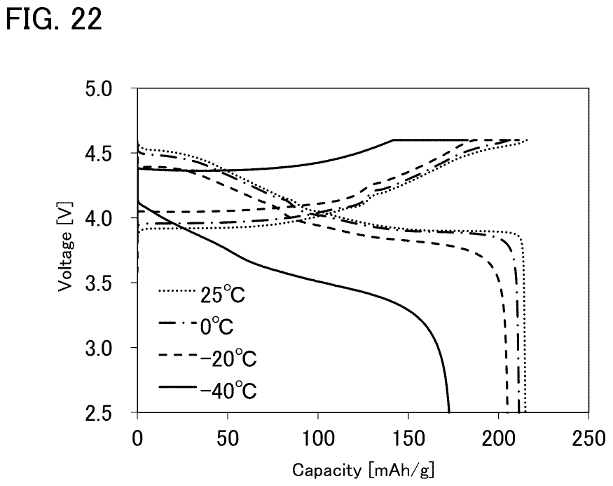

FIG. 22 shows charge curves and discharge curves (also referred to as charge and discharge curves) of the half cell 7 formed using Sample 1.

As each of the charge and discharge curves in FIG. 22, the dotted line represents a result when the temperature at a time of charge and discharge was 25° C., the dashed-dotted line represents a result when the temperature at a time of charge and discharge was 0° C., the dashed line represents a result when the temperature at a time of charge and discharge was −20° C., and the solid line represents a result when the temperature at a time of charge and discharge was −40° C. Table 4 shows measurement results of the discharge capacity, the average discharge voltage, and the discharge energy density at the temperatures at the time of charge and discharge. Table 5 shows proportions (unit: %) of the discharge capacity, the average discharge voltage, and the discharge energy density normalized by dividing the values of the discharge capacity, the average discharge voltage, and the discharge energy density at the temperatures at the time of discharge by respective values when the temperature at a time of discharge was 25° C. Note that the discharge capacity (unit: mAh/g) in Table 4 is a value calculated per weight of the positive electrode active material. Furthermore, the discharge energy density (unit: mWh/g) in Table 4 is a value calculated by multiplying the discharge capacity by the average discharge voltage (unit: V).

TABLE 4

| | |
|---|---|
| Sample name | Half cell 7 |

| | | | |
|---|---|---|---|
| Discharge | 25° | C. | 214.8 |
| capacity | 0° | C. | 211.3 |
| [mAh/g] | −20° | C. | 205.0 |
| | −40° | C. | 172.6 |
| Average | 25° | C. | 4.11 |
| discharge | 0° | C. | 4.09 |
| voltage | −20° | C. | 4.00 |
| [V] | −40° | C. | 3.58 |
| Discharge | 25° | C. | 883.8 |
| energy | 0° | C. | 863.9 |
| density | −20° | C. | 819.0 |
| [mWh/g] | −40° | C. | 617.6 |

TABLE 5

| | |
|---|---|
| Sample name | Half cell 7 |

| | | | |
|---|---|---|---|
| Proportion of | 25° | C. | 100.0 |
| 25° C. normalized | 0° | C. | 98.4 |
| discharge capacity | −20° | C. | 95.4 |
| [%] | −40° | C. | 80.3 |
| Proportion of | 25° | C. | 100.0 |
| 25° C. normalized | 0° | C. | 99.4 |
| average discharge | −20° | C. | 97.1 |
| voltage [%] | −40° | C. | 87.0 |
| Proportion of | 25° | C. | 100.0 |
| 25° C. normalized | 0° | C. | 97.7 |
| discharge energy | −20° | C. | 92.7 |
| density [%] | −40° | C. | 69.9 |

According to the results shown in FIG. 22, Table 4, and Table 5, it was revealed that the lithium ion battery including the positive electrode active material obtained by the formation method described in Embodiment 1 and the like and the electrolyte solution A was able to perform charge operation and discharge operation at least in a range of temperature which was higher than or equal to −40° C. and lower than or equal to 25° C.

As shown in FIG. 22, Table 4, and Table 5, Sample 7 exhibited extremely high discharge capacity, greater than or equal to 170 mAh/g, even at a charge temperature and a discharge temperature of −40° C. From another viewpoint, an excellent result was obtained in which the discharge capacity at the time of charge and discharge at −40° C. was greater than or equal to 80% of the discharge capacity at the time of charge and discharge at 25° C. Accordingly, the following results were obtained: the discharge capacity of the case where the charge temperature and the discharge temperature were −40° C. was greater than or equal to 170 mAh/g and the discharge capacity at the time of discharge at −40° C. is higher than or equal to 80% of the discharge capacity at the time of discharge at 25° C.

### REFERENCE NUMERALS

100: positive electrode active material, 903: mixture, 904: mixture

1. A method for forming a composite oxide, comprising:
a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours;
a second step in which a first mixture is formed by mixing a fluorine source and a magnesium source to the lithium cobalt oxide subjected to the first step;
a third step in which the first mixture is heated at a temperature higher than or equal to 800° C. and lower than or equal to 1100° C. for longer than or equal to 1 hour and shorter than or equal to 10 hours;
a fourth step in which a second mixture is formed by mixing a nickel source and an aluminum source to the first mixture subjected to the third step; and
a fifth step in which the second mixture is heated at a temperature higher than or equal to 800° C. and lower than or equal to 950° C. for longer than or equal to 1 hour and shorter than or equal to 5 hours.

2. The method for forming a composite oxide according to claim 1,
wherein a number of magnesium atoms in the magnesium source is greater than or equal to 0.3% and less than or equal to 3% of a number of cobalt atoms in the lithium cobalt oxide subjected to the first step.

3. The method for forming a composite oxide according to claim 1,
wherein the fluorine source is lithium fluoride,
wherein the magnesium source is magnesium fluoride, and
wherein a ratio between a molar number M_{LiF} of the lithium fluoride and a molar number M_{MgF2} of the magnesium fluoride is M_{LiF}:M_{MgF2}=x:1 (0.1≤x≤0.5).

4. The method for forming a composite oxide according to claim 3,
wherein a number of nickel atoms in the nickel source is greater than or equal to 0.05% and less than or equal to 4% of a number of cobalt atoms in the lithium cobalt oxide subjected to the first step.

5. The method for forming a composite oxide according to claim 4,
wherein a number of aluminum atoms in the aluminum source is greater than or equal to 0.05% and less than or equal to 4% of a number of cobalt atoms in the lithium cobalt oxide subjected to the first step.

6. The method for forming a composite oxide according to claim 5,
wherein the first step is performed in an atmosphere comprising oxygen in a state where a lid is put on a sagger comprising the lithium cobalt oxide.

7. A method for forming a lithium ion battery comprising a positive electrode comprising a positive electrode active material, an electrolyte, and a negative electrode comprising a negative electrode active material that is a carbon material, the positive electrode active material is formed through:
a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours;
a second step in which a first mixture is formed by mixing a fluorine source and a magnesium source to the lithium cobalt oxide subjected to the first step;
a third step in which the first mixture is heated at a temperature higher than or equal to 800° C. and lower than or equal to 1100° C. for longer than or equal to 1 hour and shorter than or equal to 10 hours;
a fourth step in which a second mixture is formed by mixing a nickel source and an aluminum source to the first mixture subjected to the third step; and
a fifth step in which the second mixture is heated at a temperature higher than or equal to 800° C. and lower than or equal to 1100° C. for longer than or equal to 1 hour and shorter than or equal to 5 hours.

8. A method for forming a lithium ion battery comprising a positive electrode comprising a positive electrode active material, an electrolyte, and a negative electrode comprising a negative electrode active material that is a carbon material, in which the electrolyte comprises ethylene carbonate, ethyl methyl carbonate, and dimethyl carbonate and a ratio of volume V_{EC} of the ethylene carbonate, volume V_{EMC} of the ethyl methyl carbonate, and volume V_{DMC} of the dimethyl carbonate is V_{EC}:V_{EMC}:V_{DMC}=x:y:100−x−y (5≤x≤35 and 0<y<65) when a total content of the ethylene carbonate, the ethyl methyl carbonate, and the dimethyl carbonate is set to 100 vol %, and the positive electrode active material is formed through:
a first step in which lithium cobalt oxide with a median diameter (D50) of less than or equal to 10 μm is heated at a temperature higher than or equal to 700° C. and lower than or equal to 1000° C. for longer than or equal to 1 hour and shorter than or equal to 5 hours;
a second step in which a first mixture is formed by mixing a fluorine source and a magnesium source to the lithium cobalt oxide subjected to the first step;
a third step in which the first mixture is heated at a temperature higher than or equal to 800° C. and lower than or equal to 1100° C. for longer than or equal to 1 hour and shorter than or equal to 10 hours;
a fourth step in which a second mixture is formed by mixing a nickel source and an aluminum source to the first mixture subjected to the third step; and
a fifth step in which the second mixture is heated at a temperature higher than or equal to 800° C. and lower than or equal to 1100° C. for longer than or equal to 1 hour and shorter than or equal to 5 hours.

9. The method for forming a composite oxide according to claim 1,
wherein the fluorine source is lithium fluoride, and
wherein the magnesium source is magnesium fluoride.

10. The method for forming a composite oxide according to claim 7,
wherein a number of magnesium atoms in the magnesium source is greater than or equal to 0.3% and less than or equal to 3% of a number of cobalt atoms in the lithium cobalt oxide subjected to the first step.

11. The method for forming a composite oxide according to claim 7,
wherein the fluorine source is lithium fluoride, and
wherein the magnesium source is magnesium fluoride.

12. The method for forming a composite oxide according to claim 7,
wherein the fluorine source is lithium fluoride,
wherein the magnesium source is magnesium fluoride, and
wherein a ratio between a molar number M_{LiF} of the lithium fluoride and a molar number M_{MgF2} of the magnesium fluoride is M_{LiF}:M_{MgF2}=x:1 (0.1≤x≤0.5).

13. The method for forming a composite oxide according to claim 7,
wherein a number of nickel atoms in the nickel source is greater than or equal to 0.05% and less than or equal to 4% of a number of cobalt atoms in the lithium cobalt oxide subjected to the first step.

14. The method for forming a composite oxide according to claim 7,
wherein a number of aluminum atoms in the aluminum source is greater than or equal to 0.05% and less than or equal to 4% of a number of cobalt atoms in the lithium cobalt oxide subjected to the first step.

15. The method for forming a composite oxide according to claim 8,
wherein a number of magnesium atoms in the magnesium source is greater than or equal to 0.3% and less than or equal to 3% of a number of cobalt atoms in the lithium cobalt oxide subjected to the first step.

16. The method for forming a composite oxide according to claim 8,
wherein the fluorine source is lithium fluoride, and
wherein the magnesium source is magnesium fluoride.

17. The method for forming a composite oxide according to claim 8,
wherein the fluorine source is lithium fluoride,
wherein the magnesium source is magnesium fluoride, and
wherein a ratio between a molar number M_{LiF} of the lithium fluoride and a molar number M_{MgF2} of the magnesium fluoride is M_{LiF}:M_{MgF2}=x:1 (0.1≤x≤0.5).

18. The method for forming a composite oxide according to claim 8,
wherein a number of nickel atoms in the nickel source is greater than or equal to 0.05% and less than or equal to 4% of a number of cobalt atoms in the lithium cobalt oxide subjected to the first step.

19. The method for forming a composite oxide according to claim 8,
wherein a number of aluminum atoms in the aluminum source is greater than or equal to 0.05% and less than or equal to 4% of a number of cobalt atoms in the lithium cobalt oxide subjected to the first step.
